(19) United States
(12) Patent Application Publication
(10) Pub. No.: US 2012/0328254 A1
(43) Pub. Date: Dec. 27, 2012

(54) OPTICAL FIBER AND METHOD AND APPARATUS FOR MANUFACTURING OPTICAL FIBER

(75) Inventor: Kenji OKADA, Sakura-shi (JP)

(73) Assignee: FUJIKURA LTD., Tokyo (JP)

(21) Appl. No.: 13/481,226

(22) Filed: May 25, 2012

(30) Foreign Application Priority Data
May 27, 2011 (JP) 2011-119248
May 9, 2012 (JP) 2012-107801

(51) Int. Cl. G02B 6/02; B05C 11/00

(52) U.S. Cl. 385/123; 427/163.2; 118/33

(57) ABSTRACT

An optical fiber including an optical fiber wire is provided. The optical fiber wire has a bare optical fiber portion, to which first elastic torsion is applied, and a coating layer, which coats the bare optical fiber portion and which is formed of curable resin and generates elastic repulsion against resilience occurring in the bare optical fiber portion so that the first elastic torsion applied to the bare optical fiber portion is held. Second elastic torsion is applied to the entire optical fiber configured to include the bare optical fiber portion and the coating layer.

### BACKGROUND OF THE INVENTION

1. Field of the Invention

The present invention relates to a method and apparatus for manufacturing an optical fiber represented by a silica glass-based optical fiber and in particular, to a technique for reducing polarization mode dispersion (hereinafter, referred to as “PMD”) of an optical fiber. Especially, the invention relates to an optical fiber, in which the amount of increase in the PMD is small even if subject to interference, such as lateral pressure or bending, and a method and apparatus for manufacturing an optical fiber.

Priority is claimed on Japanese Patent Application No. 2011-119248, filed May 27, 2011 and Japanese Patent Application No. 2012-107801, filed May 9, 2012, the content of which is incorporated herein by reference.

2. Description of Related Art

As is well known, a PMD is a phenomenon in which a propagation time difference (delay difference) occurs between two orthogonal polarization mode components in an optical fiber.

In addition, if a PMD increases, waveform deterioration occurs in signal light transmitted through the fiber in digital transmission, therefore, it becomes difficult to separate adjacent pulses from each other. As a result, a problem occurs in that problems arise such as the transmission capacity becoming limited. For this reason, suppressing PMD by as much as possible is desired.

In addition, the PMD is caused by the optical anisotropy of an optical fiber. The causes of the occurrence of the PMD are largely divided into internal factors, in which the optical anisotropy is caused by the internal structure, material, and the like of the optical fiber, and external factors, in which the optical anisotropy is caused by the stress from the outside of the optical fiber and the like.

The most high-impacting factor of the internal factors is the cross-sectional shape of the optical fiber.

On the other hand, in the manufacture of optical fiber wires, it is difficult in practice to realize a completely circular cross-sectional shape including the core of the optical fiber wire and the cladding around the core regardless of which fiber preform manufacturing method and method of manufacturing a bare optical fiber by drawing (fiber drawing) a fiber preform are selected.

The actual product has a cross-sectional shape distorted to, for example, a slightly elliptical shape.

If the anisotropy of such a cross-sectional shape increases, the refractive index distribution in the cross section is no longer a completely concentric circle. Accordingly, birefringence occurs, and this increases the PMD.

On the other hand, stress applied anisotropically, such as stress caused by bending or lateral pressure applied to the optical fiber from the outside, may be mentioned as the most high-impacting factor of the external factors. The birefringence also occurs due to such anisotropic stress applied from the outside, and this increases the PMD.

By the way, in order to reduce the PMD of the optical fiber, applying torsion to an optical fiber wire is effective. Accordingly, methods disclosed in Japanese Unexamined Patent Application Publication No. H8-295528, U.S. Pat. No. 6,324,872, WO2009/107667, Japanese Unexamined Patent Application Publication No. 2010-122666, and U.S. Pat. No. 7,317,855 have been proposed.

Among them, Japanese Unexamined Patent Application Publication No. H8-295528 and U.S. Pat. No. 6,324,872 disclose a method of applying torsion before an optical fiber preform is solidified when drawing a bare optical fiber, so that the torsion is permanently fixed.

The above method is a method of giving a bare optical fiber the torsion as plastic deformation (plastic torsion) so that the torsion is maintained as it is, even if the external force on the optical fiber wire is removed, that is, a method of maintaining the torsional state as permanent deformation.

Hereinafter, such a plastic torsion which remains as permanent deformation may be called a “span”.

On the other hand, WO2009/107667, Japanese Unexamined Patent Application Publication No. 2010-122666, and U.S. Pat. No. 7,317,855 disclose a method of applying torsion to an optical fiber after the optical fiber wire is drawn and solidified.

In this case, the torsion is generated due to elastic deformation.

That is, torsion in this case is elastic torsion which is released when external force is removed and accordingly the optical fiber wire returns to a free state (external force removal state).

In this case, using an optical fiber finally in the end product, such as a cable, in a state where elastic torsion is held, that is, using an optical fiber wire in a state where elastic torsion is held as an optical fiber wire used in the end products, such as a cable, is assumed.

Hereinafter, such elastic torsion may be called a “twist”.

As described above, the causes of the occurrence of the PMD are largely divided into internal factors and external factors. For the PMD caused by the internal factors, the method of applying a span (plastic torsion) to an optical fiber wire, which is disclosed in Japanese Unexamined Patent Application Publication No. H8-295528 and U.S. Pat. No. 6,324,872, is effective.

However, it is known that such a method of applying a span to an optical fiber wire is not effective for suppressing a PMD increase caused by external factors (for example, refer to WO2009/107667).

On the other hand, the method of applying a twist (elastic torsion) as disclosed in WO2009/107667, Japanese Unexamined Patent Application Publication No. 2010-122666, and U.S. Pat. No. 7,317,855 is effective for suppressing the PMD increase caused by external factors, such as lateral pressure or bending.

However, the above twist returns to the state before twisting due to elastic force when the external force is removed.

Here, in the process for making twisted optical fiber wires as an end product such as an optical cable, for example, in a coloring process, a process of arraying a plurality of optical fiber wires in a tape form, an actual mass production process including a process of forming an optical fiber cable, and inter-processes, external force such as frictional force applied to optical fiber wires may be removed or external force such as frictional force may be significantly reduced.

In this case, since the torsion is released or the torsion is significantly reduced, the effect of suppressing the PMD increase caused by external factors disappears.

Therefore, there has been a problem in that it is difficult to reliably and stably suppress the PMD increase caused by external factors in end products, such as a cable.

By the way, when applying a twist (elastic torsion) to the optical fiber as described above, it is desirable to periodically reverse the direction (clockwise direction or counterclockwise direction) of torsion applied to the optical fiber wire, as disclosed in WO2009/107667, Japanese Unexamined Patent Application Publication No. 2010-122666, and U.S. Pat. No. 7,317,855.

That is, periodically reversing the direction of torsion applied to the optical fiber wire clockwise and counterclockwise (that is, applying reverse torsion) is more effective for suppressing the PMD increase caused by external factors. In addition, by periodically reversing the direction of torsion of the optical fiber, torsion applied to the optical fiber is relatively difficult to release in each process until the end-use form is manufactured.

Here, when periodically reversing the direction of torsion applied to the optical fiber wire, the profile (reverse torsion profile) of a torsion angle (angle obtained by accumulating the torsion angle in a fixed direction for continuous torsion, that is, an accumulated torsion angle) with respect to the longitudinal distance of the optical fiber can be drawn as a sinusoidal curve, for example.

In addition, in this reverse torsion profile, the length on the optical fiber wire from the start position of torsion in a certain direction, for example, in the clockwise direction to the end position (zero torsion) of torsion in the counterclockwise direction until the torsion in the clockwise direction ends (torsion becomes 0), the direction of the torsion is reversed, and the torsion in the counterclockwise direction ends is called an inversion period of torsion.

In other words, the inversion period of torsion may also be said to be the sum of the length of a section of continuous torsion in a certain direction and the length of a section which is adjacent to the section and in which torsion continues in the opposite direction, that is, the length of two continuous sections on the optical fiber wire.

In addition, the amplitude in the reverse torsion profile indicates the maximum value (maximum accumulated torsion angle) of the accumulated torsion angle within 1 inversion period.

However, when reverse torsion is applied to the optical fiber wire as twist (elastic torsion), there is a problem in that the PMD reduction effect changes greatly due to a slight change in the inversion period or the amplitude (maximum accumulated torsion angle) of the reverse torsion profile obtained from the optical fiber wire in which twist remains (for example, refer to FIG. 5 in U.S. Pat. No. 7,317,855), if the reverse torsion profile of the twist remaining in the optical fiber wire included in the end-use form, such as a cable, is taken into consideration.

In order to solve this problem, WO2009/107667 discloses a method of finely modulating the inversion period or the amplitude of reverse torsion or setting the inversion period or the amplitude of reverse torsion randomly.

Even in this case, however, the problem of the release of torsion in each process until the end-use form is manufactured has not been solved.

For this reason, stabilization of the PMD reduction effect was insufficient.

For example, even in the case of the reverse torsion profile in which the inversion period or the amplitude is finely modulated, all torsion applied to the optical fiber wire is released in the process until the end-use form is manufactured. In addition, even if a part of torsion applied to the optical fiber wire is not released but remains until the end-use form is manufactured, a phenomenon occurs in which a modulated component with a short period is removed or a modulated component with fine amplitude becomes coarse, for example.

As a result, in the end-use form, only reverse torsion of a long period component finally remains in many cases.

Therefore, it has been difficult to stabilize the quality of an optical fiber, especially the performance of preventing the PMD increase caused by external factors in end products, such as a cable.

As described above, in the related art, it has been difficult to reliably and stably suppress the PMD increase, which is caused by external factors such as anisotropic external forces including lateral pressure or bending applied to optical fibers, in end products.

### SUMMARY

The invention has been made in view of the above situation, and it is an object of the invention to provide an optical fiber capable of reliably and stably suppressing the PMD increase, which is caused by external factors represented by anisotropic external forces such as lateral pressure or bending, even in end products, such as a cable, and a method and apparatus for manufacturing the optical fiber.

The inventors repeated various kinds of experiments and analyses in order to solve the above-described problems.

As a result, applying different kinds of elastic torsion (twist), that is, first elastic torsion and second elastic torsion in different stages of the optical fiber manufacturing process was found to be effective.

Specifically, in the process of coating liquid-state (uncured) curable resin on a bare optical fiber, which is drawn from a heated and melted optical fiber preform and is solidified, and curing the curable resin, applying first elastic torsion by applying elastic torsion to the bare optical fiber until the coating resin is cured after the bare optical fiber is solidified, fixing (holding) the applied first elastic torsion with the cured coating resin, and applying second elastic torsion to the entire optical fiber wire after curing of the curable resin were considered.

In this case, the first elastic torsion can be reliably held as elastic torsion (twist) even in an optical fiber wire used in the end-use form, such as an optical cable.

As a result, it was found that a PMD increase caused by external factors could be reliably and stably suppressed and that the PMD increase caused by external factors could be more reliably and stably suppressed by the synergistic effect of the first and second elastic torsion since the second elastic torsion applied to the optical fiber wire also slightly remained in the end-use form in many cases.

Here, the cured coating resin is also elastic. Generally, the Young's modulus of the cured coating resin is smaller than that of glass.

Accordingly, even if elastic torsion is applied to the bare optical fiber as the first elastic torsion until the coating resin is cured after the bare optical fiber is solidified as described above, it is difficult to fix the torsion by the coating resin as it is, that is, it is difficult to completely prevent an operation (release of torsion) in which elastic torsion returns to the state before twisting due to resilience using the coating resin.

In addition, when external force is removed after the application of torsion and the state changes to a free state, the release of torsion of the bare optical fiber portion to some extent cannot be avoided.

When torsion of the bare optical fiber portion is released (when the bare optical fiber portion is restored to the state before being twisted), however, torsion in the release direction (direction in which the bare optical fiber portion is restored to the state before being twisted) is applied to the coating resin layer according to the release of the torsion of the bare optical fiber portion.

As a result, the release of torsion of the bare optical fiber portion is stopped in a state where the elastic repulsive force of the coating resin against the torsion in the release direction applied to this coating resin layer and the force of the release of the torsion of the bare optical fiber portion (resilience of elastic torsion trying to return to the state before twisting) are in balance.

Therefore, elastic torsion of the bare optical fiber portion when external force is removed after torsion is applied is not eliminated 100%, and the torsion of the bare optical fiber portion is necessarily maintained at a certain level due to elastic repulsion of the coating resin.

Then, this maintained torsion is held by the coating resin even in the external force removal state, and functions as elastic torsion (twist).

As will be described later, it was confirmed that typically at least about 20% to 30% of the first elastic torsion applied in this manner remained and was held by the coating resin.

In addition, even if external force is removed when making an end product through processes, such as a process of arraying a plurality of optical fiber wires in a tape form and a process of forming an optical fiber cable, the first elastic torsion (twist) held and fixed by the coating resin in this manner is reliably held. As a result, the PMD increase caused by external factors can be stably and effectively suppressed.

Moreover, in addition to the first elastic torsion described above, second elastic torsion, which is different from the first elastic torsion, is applied to the optical fiber wire after a coating resin layer is formed on the bare optical fiber and the coating resin layer is cured, so that elastic torsion of the bare optical fiber can be reliably and stably held.

In particular, it was found that the PMD increase caused by external factors could be effectively suppressed by appropriately setting the relationship between the first elastic torsion and the second elastic torsion.

According to a first aspect of the invention, an optical fiber including an optical fiber wire is provided. The optical fiber wire includes a bare optical fiber portion, to which first elastic torsion is applied, and a coating layer, which coats the bare optical fiber portion and which is formed of curable resin and generates elastic repulsion against resilience occurring in the bare optical fiber portion so that the first elastic torsion applied to the bare optical fiber portion is held. Second elastic torsion is applied to the entire optical fiber wire including the bare optical fiber portion and the coating layer.

By using the optical fiber described above, the first elastic torsion (twist) applied to the bare optical fiber portion is held as at least a part of the amount of torsion at the time of torsion application by elastic repulsion of the coating layer against the force in the release (restoration) direction of the torsion. Accordingly, also in a state of an optical cable which is an end-use form, elastic torsion of the bare optical fiber portion can be reliably and stably held.

Therefore, it is possible to reliably and stably suppress the PMD increase caused by external factors.

In addition, in the optical fiber according to the first aspect of the invention, it is preferable that, as the first elastic torsion applied to the bare optical fiber portion, first direction torsion generated in a first direction and second direction torsion generated in a second direction, the second direction being an opposite direction to the first direction, be alternately applied to the bare optical fiber portion every predetermined length in a longitudinal direction of the optical fiber wire and as the second elastic torsion applied to the entire optical fiber wire, the first direction torsion and the second direction torsion be alternately applied to the entire optical fiber wire every predetermined length in a longitudinal direction of the optical fiber wire.

By using the optical fiber wire described above, when the first direction torsion and the second direction torsion generated in the opposite direction to the generation direction of the first direction torsion are alternately applied to the bare optical fiber portion as first elastic torsion and second elastic torsion every predetermined length in the longitudinal direction of the bare optical fiber portion, the torsion is less likely to be released compared with a case where elastic torsion is applied continuously in only one direction. As a result, the PMD increase caused by external factors can be reliably and stably suppressed.

In addition, in the optical fiber according to the first aspect of the invention, it is preferable that a sum of a length of a first section, in which the first direction torsion in the longitudinal direction of the optical fiber wire continues, and a length of a second section, which is adjacent to the first section and in which the second direction torsion continues, be defined as an inversion period of torsion and a second inversion period T2 of the second elastic torsion be longer than a first inversion period T1 of the first elastic torsion.

When the optical fiber wire described above is used, the PMD increase caused by external factors can be more reliably and stably suppressed by setting the inversion period T2 of the second elastic torsion larger than the inversion period T1 of the first elastic torsion.

In addition, in the optical fiber according to the first aspect of the invention, it is preferable that the first inversion period T1 be in a range of 5 to 10 m and the second inversion period T2 be in a range of 4 to 8 times the inversion period T1 of the first elastic torsion.

In addition, in the optical fiber according to the first aspect of the invention, it is preferable that, in a reverse torsion profile of the first elastic torsion which remains and is held by elastic repulsion of the coating layer, the maximum amplitude of an accumulated torsion angle be 100×T1 (deg) to 1200×T1 (deg) and the maximum amplitude of an accumulated torsion angle of the second elastic torsion be 300 deg to 5000 deg.

When the optical fiber wire described above is used, the PMD increase caused by external factors can be even more reliably and stably suppressed by appropriately setting the inversion periods T1 and T2 of the first and second elastic torsion and appropriately regulating the maximum angle of the accumulated torsion angle of the first and second elastic torsion.

In addition, in the optical fiber according to the first aspect of the invention, it is preferable that, in the coating layer, the amount of elastic torsion generated in a restoration direction of the first elastic torsion applied to the bare optical fiber portion be 1400 deg/m to 12800 deg/m.

Here, the amount of elastic torsion generated in the coating layer means the amount of coating layer torsion until the release of the first elastic torsion is stopped by the elastic repulsion of the coating layer against the force of the release of the torsion after the coating layer is twisted in the release direction of the first elastic torsion.

That is, assuming that the amount of first elastic torsion applied to the optical fiber wire (before the coating layer is cured) is A (deg), the amount of elastic torsion, which remains in the bare optical fiber portion due to the balance of the force of elastic torsion of the bare optical fiber portion and the elastic repulsion of the coating layer after the coating layer is cured (in a state where external force is removed), of the applied first elastic torsion is B (deg), and the inversion period of the first elastic torsion is T1 (m), the amount of applied torsion (deg/m) is given by the following Expression (A−B)/(T1/4).

When the optical fiber wire described above is used, the amount of elastic torsion of the coating layer generated according to the application of the first elastic torsion is appropriately set. Accordingly, appropriate elastic repulsion is generated in the coating layer.

As a result, at least a part of elastic torsion applied to the optical fiber wire can be reliably held in the bare fiber portion.

Therefore, it is possible to suppress the PMD increase caused by external factors more reliably and stably and also to prevent the occurrence of peeling or cracking in the coating layer.

In addition, according to a second aspect of the invention, a method for manufacturing the optical fiber is provided to which the above-described first and second elastic torsion is applied.

The optical fiber manufacturing method according to a second aspect of the invention includes: coating a bare optical fiber portion with uncured curable resin; applying first elastic torsion to an optical fiber wire before the curable resin is cured; forming an optical fiber wire to which torsion is applied so that the first elastic torsion of the bare optical fiber portion is held by curing the curable resin coated on the bare optical fiber portion to which the first elastic torsion is applied; and applying second elastic torsion to the entire optical fiber wire after the curable resin is cured.

When the optical fiber manufacturing method described above is used, the PMD increase caused by external factors can be suppressed by the residue of the first elastic torsion even if the second elastic torsion is completely released in the process until the end-use form is obtained.

In addition, in the optical fiber manufacturing method according to the second aspect of the invention, it is preferable that an optical fiber preform be heated and melted, a bare optical fiber portion with a predetermined diameter be drawn from the melted optical fiber preform, the drawn bare optical fiber portion be solidified, the first elastic torsion be applied to the solidified bare optical fiber portion by transmitting elastic torsion to the bare optical fiber portion toward an upstream side in a drawing direction of the bare optical fiber portion, a coating layer before curing be formed by coating an outer periphery of the solidified bare optical fiber portion with curable resin in a liquid state, at least a part of the first elastic torsion be held in the bare optical fiber portion by curing the coating layer formed on the outer periphery of the bare optical fiber portion to which the first elastic torsion is applied, and second elastic torsion be applied to the entire optical fiber wire obtained after curing of the curable resin.

When the optical fiber manufacturing method described above is used, it is possible to manufacture the optical fiber in which the first elastic torsion (twist) applied to the solidified bare optical fiber is held by the cured coating layer, that is, the optical fiber in which elastic torsion remains in the bare optical fiber portion even after external force is removed.

In addition, in the optical fiber manufacturing method according to the second aspect of the invention, it is preferable that the first elastic torsion be applied to the bare optical fiber portion using a first torsion application device and the first elastic torsion be applied to the bare optical fiber portion in a state where a member, the member preventing transmission of torsion of the bare optical fiber portion, is not present at an upstream side of the first torsion application device.

When the optical fiber manufacturing method described above is used, torsion is smoothly transmitted from the first torsion application device to the upstream side of the first torsion application device. As a result, the first elastic torsion can be reliably and stably applied to the bare optical fiber portion.

In addition, in the optical fiber manufacturing method according to the second aspect of the invention, it is preferable that, when the bare optical fiber portion is coated with curable resin, viscosity of the curable resin in a liquid state at the time of coating be 0.1 to 3 Pa·sec. In addition, preferably, when applying the first elastic torsion to the optical fiber wire, a direction of torsion applied to the bare optical fiber portion is periodically reversed.

When the optical fiber manufacturing method described above is used, a change in the external diameter of the coat of the optical fiber wire can be suppressed by setting the viscosity of the liquid-state resin at the time of coating to 0.1 Pa·sec or more. As a result, it is possible to obtain the optical fiber wire with a coat having a uniform external diameter.

In addition, by setting the viscosity of the liquid-state resin at the time of coating to 3 Pa·sec or less, it is possible to prevent the liquid-state resin from becoming resistant against the transmission of torsion from the first torsion application device. In particular, when the direction of the first elastic torsion is periodically reversed, the torsion is made to be reliably transmitted and the torsional direction is made to be reliably reversed, so that the PMD increase caused by external factors can be more reliably suppressed.

In addition, in the optical fiber manufacturing method according to the second aspect of the invention, it be preferable that a sum of a length of a first section, in which first direction torsion generated in a first direction in a longitudinal direction of the optical fiber wire continues, and a length of a second section, which be adjacent to the first section and in which second direction torsion generated in a second direction opposite the first direction continues, be defined as an inversion period of torsion, when applying the first elastic torsion to the optical fiber wire, a direction of the torsion be periodically reversed, when applying the second elastic torsion to the optical fiber wire, a direction of the torsion be periodically reversed, and a second inversion period T2 of the second elastic torsion be longer than a first inversion period T1 of the first elastic torsion

When the optical fiber manufacturing method described above is used, it is possible to manufacture an optical fiber capable of reliably suppressing the PMD increase caused by external factors.

In addition, in the optical fiber manufacturing method according to the second aspect of the invention, it is preferable that, when applying the first elastic torsion to the optical fiber wire, the first inversion period T1 of the first elastic torsion in the longitudinal direction of the optical fiber wire be 5 to 10 m. In addition, preferably, in a reverse torsion profile of the first elastic torsion, the maximum amplitude of an accumulated torsion angle is 500×T1 (deg) to 4000×T1 (deg).

When the optical fiber manufacturing method described above is used, the inversion period T1 of the first elastic torsion is set within the above range and the maximum amplitude of the accumulated torsion angle is set within the above range. As a result, first elastic torsion remaining when external force on the optical fiber wire is removed can be sufficiently secured, and peeling or cracking occurring in the coating layer due to excessive stress on the coating layer can be prevented.

In addition, in the optical fiber manufacturing method according to the second aspect of the invention, it is preferable that the first inversion period T1 of the bare optical fiber portion, in which at least a part of the first elastic torsion applied to the optical fiber wire is held due to elastic repulsion of the coating layer, in the longitudinal direction of the optical fiber wire be 5 to 10 m. In addition, preferably, in a reverse torsion profile of the optical fiber wire, the maximum amplitude MA of an accumulated torsion angle is 100×T1 (deg) to 1200×T1 (deg).

When the optical fiber manufacturing method described above is used, force of the release of the first elastic torsion applied to the optical fiber wire and elastic repulsion of the coating layer against the force of the release are in balance and accordingly, at least a part of the first elastic torsion applied to the optical fiber wire remains in a portion of the bare optical fiber portion.

In this state where the elastic torsion remains, the inversion period T1 of the first elastic torsion is set within the above range and the maximum amplitude MA of the accumulated torsion angle is set within the above range, so that a sufficient amount of elastic torsion remains in the optical fiber wire. As a result, the PMD increase caused by external factors can be more reliably and stably suppressed.

In addition, in the optical fiber manufacturing method according to the second aspect of the invention, it is preferable that, when at least a part of the first elastic torsion applied to the optical fiber wire is held in the bare optical fiber portion, the amount of elastic torsion, which is generated in a restoration direction of the first elastic torsion applied to the bare optical fiber portion, in the coating layer be 1400 deg/m to 12800 deg/m.

When the optical fiber manufacturing method described above is used, appropriate elastic repulsion is generated in the coating layer by appropriately setting the amount of elastic torsion of the coating layer generated according to the application of the first elastic torsion.

As a result, at least a part of elastic torsion applied to the bare optical fiber portion can be reliably held.

Therefore, it is possible to suppress the PMD increase caused by external factors even more reliably and stably and also to prevent the occurrence of peeling or cracking in the coating layer.

In addition, in the optical fiber manufacturing method according to the second aspect of the invention, it is preferable that the second inversion period T2 be 4 to 8 times the first inversion period T1 when applying the first elastic torsion and the maximum amplitude of an accumulated torsion angle when applying the second elastic torsion be 300 deg to 5000 deg.

When the optical fiber manufacturing method described above is used, the PMD increase caused by external factors can be even more reliably and stably suppressed by appropriately setting the inversion period T2 of the second elastic torsion and appropriately regulating the maximum angle of the accumulated torsion angle of the second elastic torsion.

In addition, according to a third aspect of the invention, an apparatus for manufacturing an optical fiber includes: a heating furnace for drawing which heats and melts an optical fiber preform; a cooling device which forcibly cools a bare optical fiber portion, which is linearly drawn downward from the heating furnace for drawing, in order to solidify the bare optical fiber portion; a coating device which forms a coating layer by coating curable resin for protecting the bare optical fiber portion on the cooled and solidified bare optical fiber portion; a coat-curing device which cures the uncured coating layer coated by the coating device; a first torsion application device which gives first elastic torsion to the solidified bare optical fiber portion by transmitting elastic torsion to the bare optical fiber portion toward an upstream side in a drawing direction of the bare optical fiber portion; and a second torsion application device which applies second elastic torsion, which is different from the first elastic torsion, to an entire optical fiber wire in which at least a part of the first elastic torsion applied to the bare optical fiber portion is held.

In the optical fiber of the invention, even after the external force is removed, the first elastic torsion (first twist) applied to the bare optical fiber portion is held by elastic repulsion of the coating layer against the force in the release direction of the elastic torsion.

For this reason, also in the state of an optical cable which is an end-use form, it is possible to reliably and stably hold the first elastic torsion of the bare fiber portion. In addition, by applying the second elastic torsion (second twist) further, it is possible to make the second elastic torsion remain slightly in the end-use form.

As a result, the PMD increase caused by external factors, such as bending or lateral pressure, can be reliably and stably suppressed.

Moreover, when elastic torsion is applied alternately in the opposite directions as in the technique proposed in the related art, it is not necessary to modulate the period or amplitude of the reverse profile finely.

As a result, it is possible to effectively prevent the occurrence of the situation where a fine modulated component of the reverse profile is lost or becomes coarse in the process until the end-use form is manufactured and the PMD reduction effect is reduced.

In addition, according to the optical fiber manufacturing method and the optical fiber manufacturing apparatus of the invention, it is possible to practically easily manufacture the optical fiber capable of reliably and stably suppressing the PMD increase caused by external factors, such as bending or lateral pressure, as described above.

### BRIEF DESCRIPTION OF THE DRAWINGS

FIG. 1 is a schematic view showing an example of a part of a wire manufacturing apparatus in an apparatus for manufacturing an optical fiber of the invention.

FIG. 2A is a view showing an example of a first torsion application device used in the apparatus for manufacturing the optical fiber of the invention, and is a plan view seen from above the torsion application device.

FIG. 2B is a view showing an example of the first torsion application device used in the apparatus for manufacturing the optical fiber of the invention, and is a front view of the torsion application device.

FIG. 3 is a front view showing another example of the first torsion application device used in the apparatus for manufacturing the optical fiber of the invention.

FIG. 4 is a partially cut perspective view schematically showing a situation of an example of an optical fiber wire immediately after curing of a coating layer in the optical fiber manufacturing process of the invention.

FIG. 5 is a schematic sectional view of an optical fiber wire, which schematically shows a situation when external force on the optical fiber of the invention is removed.

FIG. 6A is a perspective view showing a state immediately after a coating layer of the optical fiber wire shown in FIG. 4 is cured, and is a view for explaining the internal structure of the optical fiber wire immediately after curing of the coating layer.

FIG. 6B is a perspective view showing a state after external force applied to the optical fiber wire shown in FIG. 4 is removed, and is a view for explaining the internal structure of the optical fiber wire.

FIG. 7 is a graph showing an example of the profile of reverse torsion in the optical fiber of the invention.

FIG. 8 is a schematic view showing the overall configuration of another example of a part of a wire manufacturing apparatus in an apparatus for manufacturing an optical fiber of the invention.

FIG. 9 is a schematic view showing an example of a second torsion application device used in the apparatus for manufacturing the optical fiber of the invention.

FIG. 10 is a graph showing a first example, which shows the relationship between the amplitude (maximum accumulated torsion angle) and the inversion period of the reverse profile of torsion and the PMD change rate when one type of torsion, which has a periodically reversed torsional direction, is applied to an optical fiber wire as elastic torsion.

FIG. 11 is a graph showing a first example, which shows the relationship between the amplitude (maximum accumulated torsion angle) and the inversion period of the reverse profile of torsion and the PMD change rate when two types of torsion, which have a periodically reversed torsional direction, are applied to an optical fiber wire as elastic torsion.

FIG. 12 is a graph showing a second example, which shows the relationship between the amplitude (maximum accumulated torsion angle) and the inversion period of the reverse profile of torsion and the PMD change rate when two types of torsion, which have a periodically reversed torsional direction, are applied to an optical fiber wire as elastic torsion.

FIG. 13 is a graph showing a third example, which shows the relationship between the amplitude (maximum accumulated torsion angle) and the inversion period of the reverse profile of torsion and the PMD change rate when two types of torsion are applied.

FIG. 14 is a graph showing a fourth example, which shows the relationship between the amplitude (maximum accumulated torsion angle) and the inversion period of the reverse profile of torsion and the PMD change rate when two types of torsion are applied.

FIG. 15 is a graph showing a fifth example, which shows the relationship between the amplitude (maximum accumulated torsion angle) and the inversion period of the reverse profile of torsion and the PMD change rate when two types of torsion are applied.

FIG. 16 is a graph showing a sixth example, which shows the relationship between the amplitude (maximum accumulated torsion angle) and the inversion period of the reverse profile of torsion and the PMD change rate when two types of torsion are applied.

### DETAILED DESCRIPTION OF THE INVENTION

Hereinafter, each embodiment of the invention will be described in detail with reference to the accompanying drawings.

In the invention, two kinds of elastic torsion, that is, the first elastic torsion and the second elastic torsion are applied to an optical fiber wire.

In addition, between the first elastic torsion and the second elastic torsion applied to an optical fiber wire, the first elastic torsion is applied by a first torsion application device in a process of forming a resin coating layer by drawing a bare optical fiber from an optical fiber preform, that is, in a process of manufacturing an optical fiber wire.

On the other hand, the second elastic torsion is applied by a second torsion application device after the resin coating layer is cured to become an optical fiber wire, that is, in a stage before the optical fiber wire manufactured in the fiber optic fiber manufacturing process is wound or in a stage after the manufactured optical fiber wire is once wound.

In the following embodiments, in order to simplify the explanation, the second elastic torsion applied to the optical fiber wire is assumed to be applied in a stage after the manufactured optical fiber wire is once wound.

In addition, in this case, an optical fiber wire manufacturing apparatus including the first torsion application device and a device, which applies the second torsion by rewinding the optical fiber wire manufactured by the optical fiber wire manufacturing apparatus and wound, will be described separately.

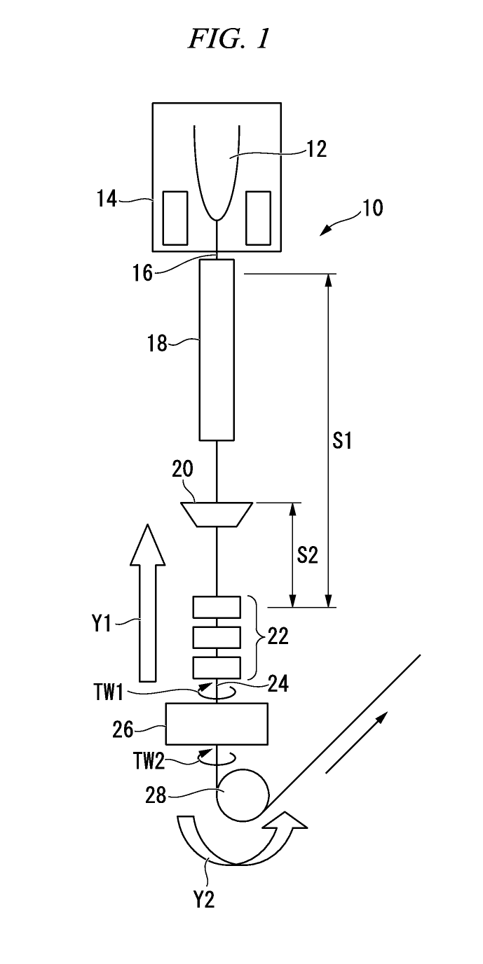

First, FIG. 1 shows an example of an apparatus for manufacturing an optical fiber, that is, an optical fiber wire manufacturing apparatus 10 including a first torsion application device, in an apparatus for manufacturing an optical fiber wire of the invention. The process of manufacturing an optical fiber wire while applying the first elastic torsion will be described with reference to FIG. 1.

In FIG. 1, the optical fiber wire manufacturing apparatus 10 includes a heating furnace for drawing 14, a cooling device 18, a coating device 20, a coat-curing device 22, a first torsion application device 26, a pickup device (not shown), and a winding device (not shown).

The heating furnace for drawing 14 heats and melts an optical fiber preform 12 formed of silica-based glass, for example.

The cooling device 18 forcibly cools a bare optical fiber 16, which is linearly drawn downward from the heating furnace for drawing 14, to solidify the bare optical fiber 16.

The coating device 20 coats the cooled and solidified bare optical fiber 16 with curable resin for protective coating, such as ultraviolet curable resin or thermosetting resin.

The coat-curing device 22 cures the uncured (liquid-state) curable resin, which has been coated by the coating device 20, by ultraviolet irradiation or heating.

The first torsion application device 26 applies the first elastic torsion to the optical fiber wire 24 in a state where the curable resin for protective coating is cured.

The pickup device picks up the optical fiber wire 24, to which the first elastic torsion has been applied, through a guide pulley 28 or a dancer roller (not shown).

The winding device winds the optical fiber wire finally.

Here, although the first torsion application device 26 may be configured to continuously apply torsion to the optical fiber wire 24 in a fixed direction, it is typically desirable to configure the first torsion application device 26 such that the torsional direction (clockwise direction or counterclockwise direction) is periodically reversed, as will be described again later.

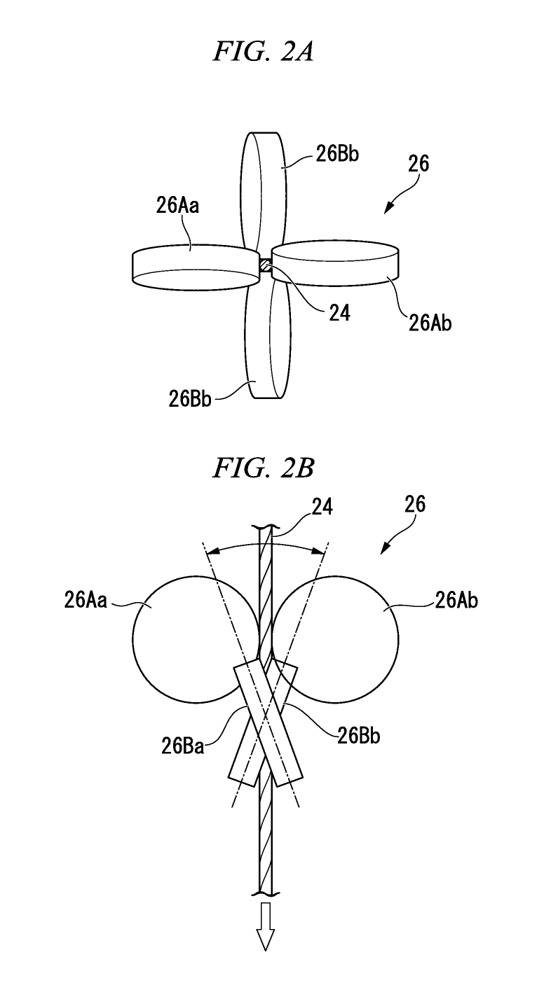

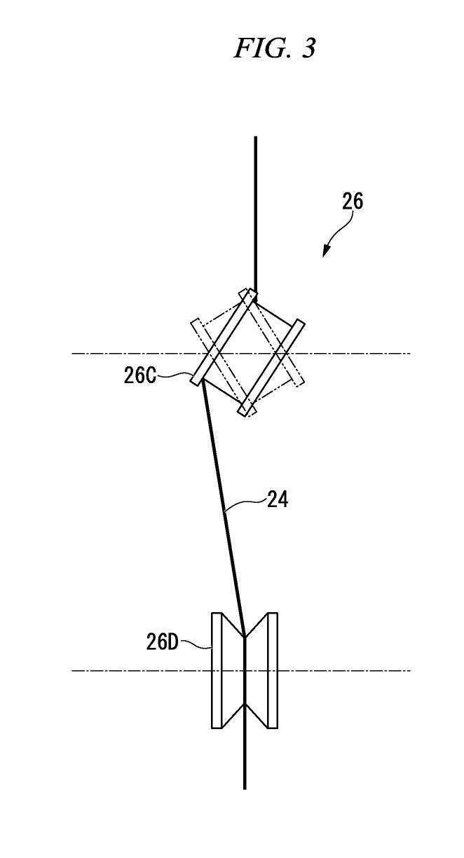

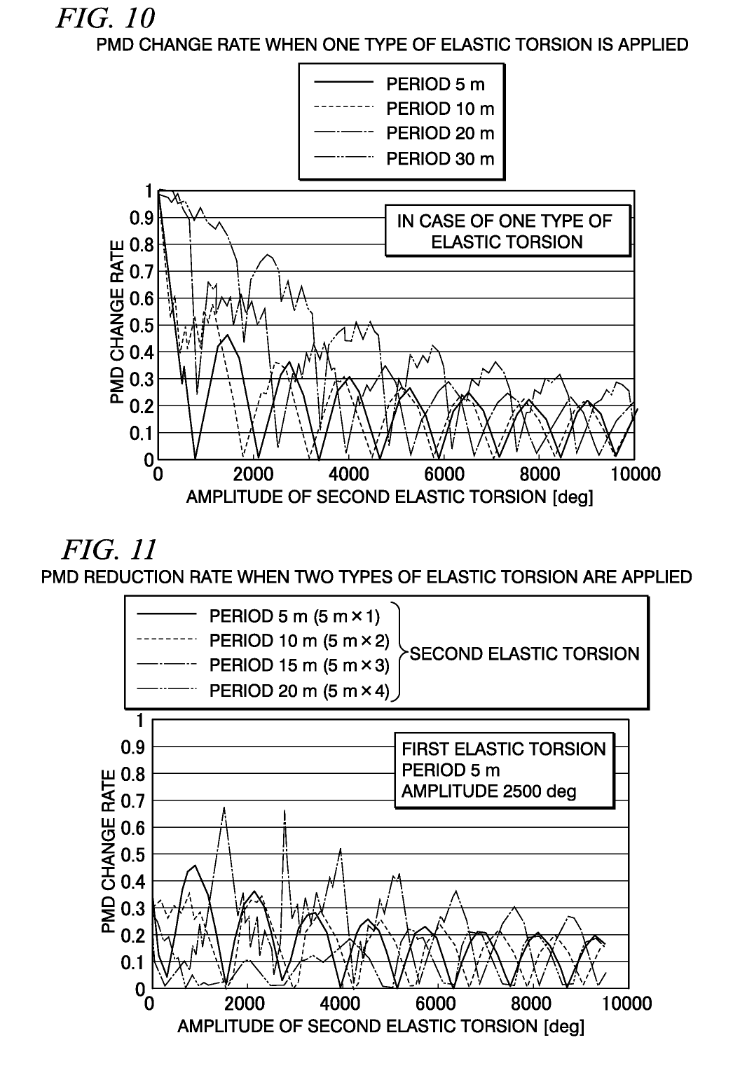

Although the specific configuration of the first torsion application device 26 is not limited in particular, it is preferable to apply a torsion application device shown in FIGS. 2A and 2B (the same device as the torsion application device shown in FIG. 11 of Japanese Unexamined Patent Application Publication No. 2010-122666) or a torsion application device shown in FIG. 3 (the same device as the torsion application device shown in FIGS. 2A and 2B of Japanese Unexamined Patent Application Publication No. H8-295528 or FIG. 10 of Japanese Unexamined Patent Application Publication No. 2010-122666), for example.

The torsion application device 26 shown in FIGS. 2A and 2B is formed by two torsion application roller pairs 26Aa and 26Ab and 26Ba and 26Bb, each pair of torsion application rollers rotating with the optical fiber wire 24 interposed between both the sides.

The second pair of torsion application rollers 26Ba and 26Bb are provided at the positions near the first pair of torsion application rollers 26Aa and 26Ab at the downstream side of the first pair of torsion application rollers 26Aa and 26Ab (side at which the guide pulley 28 in FIG. 1 is provided).

In addition, the second pair of torsion application rollers 26Ba and 26Bb are disposed so as to be shifted by 90 degree from the first pair of torsion application rollers 26Aa and 26Ab with the center on a cross section, which is perpendicular to the longitudinal direction (fiber drawing direction) of the optical fiber wire 24, as the axis.

In addition, when each of the torsion application roller pairs 26Aa and 26Ab and 26Ba and 26Bb rotate with the optical fiber wire 24 interposed between both the sides, torsion can be applied to the optical fiber wire 24 by making the rotary axis of each of the torsion application pairs 26Aa and 26Ab and 26Ba and 26Bb inclined by a predetermined angle in a direction perpendicular to the longitudinal direction of the optical fiber wire 24.

In addition, by changing the inclination direction of each of the torsion application roller pairs 26Aa and 26Ab and 26Ba and 26Bb with respect to the optical fiber wire 24 to the opposite direction, the direction of torsion applied to the optical fiber wire 24 can be changed.

In addition, the torsion application device 26 shown in FIG. 3 includes a torsion application roller 26C, which has the optical fiber wire 24 wound on its outer periphery and which rotates around the rotary axis inclined with respect to the fiber drawing direction, and a fixed position roller 26D, which is disposed at the downstream side of the torsion application roller 26C and which rotates around the rotary axis perpendicular to the fiber drawing direction.

In addition, torsion is applied to the optical fiber wire 24 by rolling the optical fiber wire 24 on the outer periphery of the torsion application roller 26C along the rotary axis direction, and the torsional direction can be reversed by performing swinging so that the inclination direction of the torsion application roller 26C is reversed.

In addition, it is preferable to provide the first torsion application device 26 at the position where torsion can be applied after coating the cooled and solidified bare optical fiber 16 with curable resin for protective coating and curing the curable resin.

However, at the upstream side of the first torsion application device 26, it is preferable not to provide a mechanism or a member which prevents the transmission of torsion in contact with the optical fiber wire 24 or the bare optical fiber 16.

In addition, in the optical fiber wire manufacturing apparatus 10 shown in FIG. 1, the first torsion application device 26 is disposed between the coat-curing device 22 and the guide roller 28 so that the above-described conditions are satisfied.

In this case, at the upstream side of the first torsion application device 26, there is no member which physically contacts the surface of the optical fiber wire 24 or the bare optical fiber 16 except for curable coating resin.

Therefore, by transmitting the torsion applied by the first torsion application device 26 continuously and smoothly to the upstream side, it is possible to apply elastic torsion (twist), which is an object of the invention.

However, in the case of a member for which the rolling of an optical fiber is allowed, such as a flat groove pulley with a certain amount of groove width, a possibility that the member will prevent the transmission of torsion is low even if the member is in contact with the optical fiber. Accordingly, such a member may be provided at the upstream side of the first torsion application device 26.

In addition, although the curable resin coated by the coating device 20 may have one layer, a two-layer structure of a first coating layer (primary material) and a second coating layer (secondary material) is generally used in many cases. Also in the invention, therefore, it is desirable to form a resin coating layer with a two-layer structure.

That is, as the primary coat layer, it is preferable to use ultraviolet-curable resin, such as epoxy acrylate resin or urethane acrylate resin, or to use thermosetting resin, such as silicon resin, with a low Young's modulus after curing which is about 5 MPa or less (generally, the Young's modulus at room temperature is 0.3 to 1.5 MPa).

On the other hand, as the second coating layer, it is preferable to use ultraviolet-curable resin, such as epoxy acrylate resin or urethane acrylate resin, or to use thermosetting resin, such as modified silicon resin, with a high Young's modulus after curing which is about 100 MPa or more (generally, the Young's modulus at room temperature is 300 to 1500 MPa).

Since a material with a low Young's modulus is used as the first coating layer as described above, it is possible to exhibit a good cushioning effect for a bare optical fiber and to improve the adhesion of the coating layer to the bare optical fiber.

In addition, since a material with a high Young's modulus is used as the second coating layer, the curable resin can sufficiently withstand external damage, friction, lateral pressure, and the like.

In particular, in the case of the optical fiber of the invention, increasing the apparent Young's modulus of the entire coating layer while improving the adhesion to a bare optical fiber portion is advantageous in holding first elastic torsion (first twist) of the bare optical fiber portion with the coating layer.

Therefore, also from this point of view, it is desirable to form a coating layer with a two-layer structure in which two layers have different Young's moduli after curing.

In addition, as a coating method and a curing method when forming a coating layer with such a two-layer structure, it is possible to provide each of the coating device 20 and the coat-curing device 22 in only one place, perform two-layer coating using one coating device 20, and cure the obtained coating layer with a two-layer structure collectively using three coat-curing devices 22, as shown in FIG. 1.

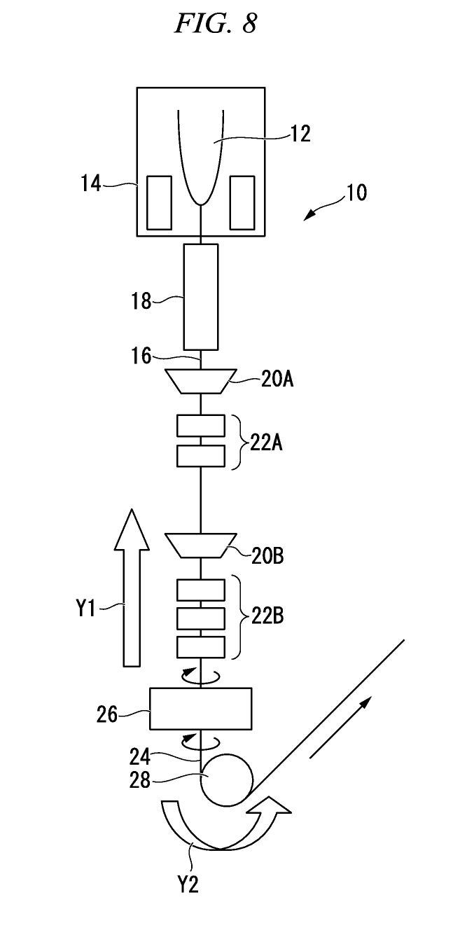

Alternatively, as shown in FIG. 8 which will be described later, it is also possible to provide each of the coating device 20 and the coat-curing device 22 in two places, coat resin of the first coating layer and cure the resin, and then coat resin of the second coating layer and cure the resin.

In addition, although the viscosity of the resin in a liquid state when coating the curable resin on a bare optical fiber is also a factor which affects the application situation of the first elastic torsion (first twist) and the like, explanation thereof will be given later.

Next, a method of manufacturing an optical fiber wire while applying the first elastic torsion (first twist) using the above optical fiber wire manufacturing apparatus will be described.

When manufacturing an optical fiber wire using the above optical fiber wire manufacturing apparatus, the optical fiber preform 12, such as a quartz-based glass preform which is a raw material of a bare optical fiber, is heated and melted at high temperature of 2000° C. or more in the heating furnace for drawing 14, the melted preform is pulled out downward from the lower portion of the heating furnace for drawing 14 while extending it as the bare optical fiber 16 in a high temperature state, and the bare optical fiber 16 is solidified by cooling using the cooling device 18.

On the bare optical fiber 16 solidified by cooling down to the necessary temperature using the cooling device 18, two kinds of curable resin including ultraviolet-curable resin and thermosetting resin are coated as first and second coating layers in a liquid state by the coating device 20 for two-layer coating, for example.

In addition, the obtained coating resin is cured by the coat-curing device 22 using an appropriate curing method according to the resin type, such as ultraviolet-curable resin or thermosetting resin. As a result, the optical fiber wire 24 including two coating layers is obtained.

In addition, predetermined torsion TW1 and TW2 is applied to the obtained optical fiber wire 24 by the first torsion application device 26 shown in FIGS. 2A and 2B or FIG. 3, for example. Then, the optical fiber wire 24 is picked up at predetermined speed by a pickup device (not shown) through the guide pulley 28 and is wound by a winding device (not shown).

In the apparatus shown in FIG. 1, the torsion TW1 and TW2 applied to the optical fiber wire 24 by the first torsion application device 26 is transmitted before and after the first torsion application device 26 (upstream and downstream sides of the first torsion application device 26), as shown by the arrows Y1 and Y2 in FIG. 1. However, the torsion TW1 transmitted to the optical fiber preform side (upstream side) is focused in particular herein.

In this case, the torsion TW1 passes the coating device 20 through the coat-curing device 22 and is then transmitted toward the upper cooling device 18.

Accordingly, the bare optical fiber 16 is solidified by the cooling device 18, and then uncured (liquid-state) curable resin is coated on the outer periphery of the bare wire by the coating device 20 and torsion is applied until the coating resin is cured by the coat-curing device 22 (near the region indicated by the reference numeral 51 in FIG. 1).

Here, the torsion applied after the bare optical fiber is solidified is torsion which is released when external force is removed, that is, elastic torsion (twist).

In addition, the torsion applied to the optical fiber wire 24 by the first torsion application device 26 after the coating resin is cured is also applied undoubtedly to the coating layer united with the bare optical fiber portion.

On the other hand, until the resin is cured after the resin is coated in a liquid state by the coating device 20 (near the region S2 in FIG. 1), the coating resin may flow. Accordingly, the coating resin does not show its elastic behavior during this period.

Therefore, in the region S2, elastic torsion is not substantially applied to the coating layer.

In addition, when the resin coated in a liquid state on the outer periphery of the bare optical fiber is cured, the first elastic torsion (first twist) of the bare optical fiber applied until then is fixed (held) by resin of the coating layer

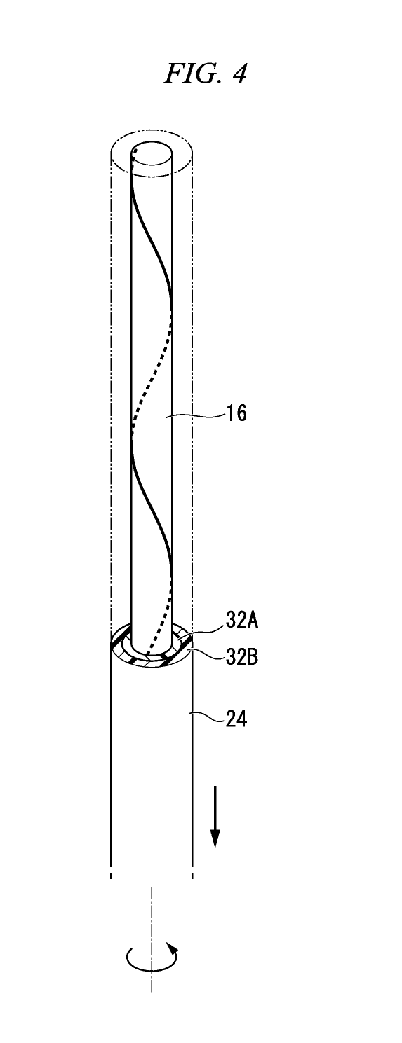

Here, FIG. 4 schematically shows an example of the optical fiber wire 24 in a stage where a coating layer is cured by the coat-curing device 22 in the manufacturing process of the optical fiber wire 24 manufactured by the above-described apparatus in FIG. 1.

In FIG. 4, reference numerals 32A and 32B indicate first and second coating layers of the coating layer, respectively, and a thick solid line and a thick dotted line drawn on the outer periphery of the bare optical fiber 16 in FIG. 4 indicate applied torsion.

This drawing shows a state where clockwise torsion is applied when seen from the downstream side in the optical fiber wire manufacturing process and accordingly, clockwise torsion is applied to a portion of the bare optical fiber 16 when seen from the lower side.

As already described, the coating layers 32A and 32B do not show elastic behaviors until they are cured after being coated in a liquid state on the outer periphery of the bare optical fiber 16.

Accordingly, in the stage shown in FIG. 4, torsion is not substantially applied to the coating layers 32A and 32B.

As will be described later, an optical fiber wire in a stage where external force, such as friction, is not removed is shown in FIG. 4.

By the way, the cured coating resin is softer than the bare optical fiber portion and has low rigidity. Accordingly, even if elastic torsion is applied to the optical fiber wire until the coating resin is cured after the bare optical fiber is solidified as described above, it is difficult to completely fix the applied elastic torsion as it is by the coating resin, that is, it is difficult to completely prevent the release (restoration) of torsion caused by the elastic force when external force is removed.

That is, if external force, such as a frictional force, is then removed from the optical fiber wire to which torsion has been applied, the resin coating layer is twisted in a release direction of the bare optical fiber portion by the elastic release force of the bare optical fiber portion inside the optical fiber wire. Accordingly, the elastic torsion of the bare fiber portion is also inevitably released to some extent.

However, since the cured coating resin is also elastic, torsion in the release direction which is applied to the coating resin layer when the torsion of the bare optical fiber portion is released also serves as elastic torsion. Accordingly, the release of torsion of the bare optical fiber portion is stopped when the repulsive force against elastic torsion of the coating resin layer and the force of the release of the torsion of the bare optical fiber portion (resilience of elastic torsion trying to return to the state before twisting) are in balance.

Therefore, the elastic torsion applied to the bare optical fiber portion when external force is removed is not eliminated 100%, but the elastic torsion applied to the bare optical fiber portion is necessarily left at a certain rate due to elastic repulsion of the coating resin.

The torsion component of the first elastic torsion left in this manner is held and fixed by the coating resin, and also functions as elastic torsion (twist) contributing to PMD suppression in end products.

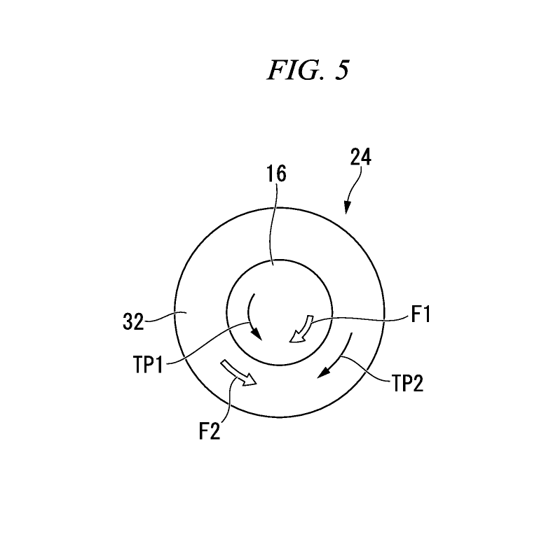

FIG. 5 schematically shows the relationship between the torsion and the balance of the force when external force, such as friction, applied to the optical fiber wire, is removed as described above.

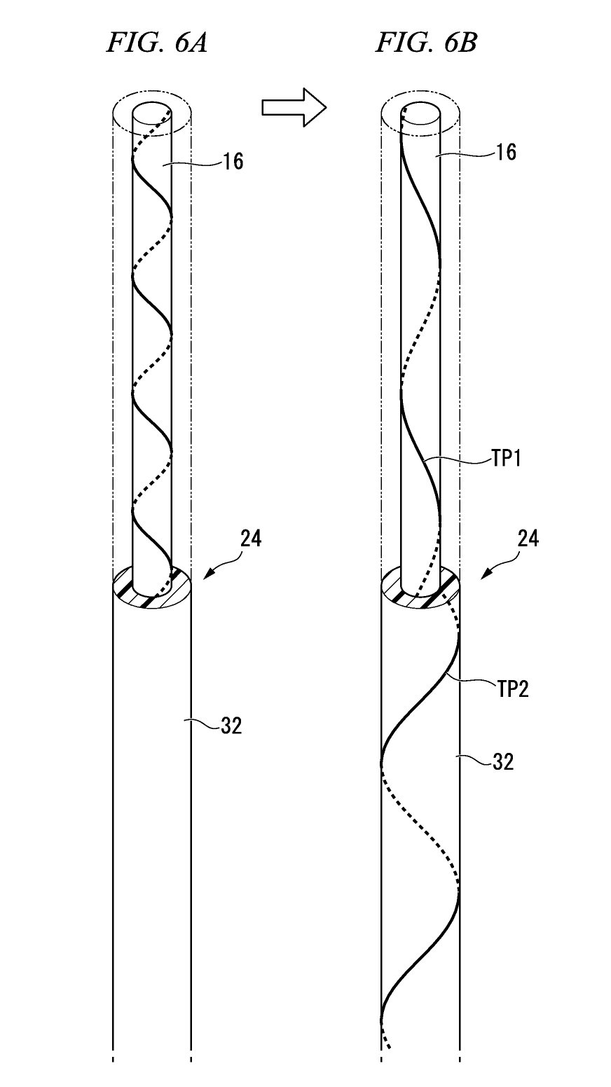

In addition, FIG. 6B schematically shows a situation of torsion of an optical fiber wire in a free state after external force, such as friction, applied to the optical fiber wire, is removed (state where no external force is applied to the optical fiber wire).

In addition, for the sake of comparison, a torsion situation immediately after a coating layer is cured is shown in FIG. 6A (substantially the same as FIG. 4).

In FIGS. 6A and 6B, a thick solid line and a thick dotted line indicate a torsion situation.

In FIGS. 5, 6A, and 6B, for simplicity of explanation, a case where the coating layer has one layer (reference numeral 32) is shown.

In FIG. 5, for example, counterclockwise elastic torsion TP1 is applied to a portion of the bare optical fiber 16 until just before external force applied to the optical fiber wire is removed.

On the other hand, when external force is removed to reach a free state, an elastic return force F1 works clockwise to reduce the counterclockwise elastic torsion TP1.

This means that the bare optical fiber 16 is twisted clockwise when external force is removed.

As a result, the coating layer 32 adhering to the bare optical fiber 16 is also twisted clockwise (torsion TP2).

In this case, since the coating layer 32 is also elastic, an elastic repulsive force F2 is generated in the opposite direction (counterclockwise direction) to the clockwise torsion TP2.

Then, the elastic torsion TP1 of the portion of the bare optical fiber 16 is held in a state where the counterclockwise elastic repulsive force F2 of the coating layer 32 and the clockwise elastic repulsive force F1 of the above-described bare optical fiber 16 are in balance.

Accordingly, in the optical fiber wire in a free state after external force, such as friction, applied to the optical fiber wire, is removed, the torsion TP1 and TP2 in opposite directions remains in the portion of the bare optical fiber 16 and the portion of the coating layer 32, as shown in FIG. 6B. The torsion TP1 remaining in the portion of the bare optical fiber 16 is smaller than the torsion immediately after curing of the coating layer (thick solid line and dotted line in FIG. 6A).

Here, the Young's modulus of the cured coating resin is generally quite low compared with that of optical fiber glass, but is not zero.

Therefore, when external force is removed, elastic repulsive force by torsion of the resin coating layer caused by the release of torsion of the bare optical fiber portion is necessarily generated. As a result, a part of elastic torsion applied to the bare optical fiber portion remains in a state where the repulsive forces are in balance as described above.

In a coating layer with a two-layer structure which is used in a typical optical fiber, a material whose Young's modulus at room temperature is about 0.3 to 1.5 MPa is used as a resin (primary material) of the first coating layer and a material whose Young's modulus at room temperature is about 300 to 1500 MPa is used as a resin (secondary material) of the second coating layer.

In addition, the diameter of the bare optical fiber is about 125 μm. Of the external diameters of the coating layer, the external diameter of the first coating layer (primary layer) is about 170 to 210 μm and the external diameter of the second coating layer (secondary layer) is about 230 to 260 μm.

In addition, elastic torsion was applied to such an optical fiber wire as described above and then external force applied to the optical fiber wire was removed, and residual torsion of the bare optical fiber was checked. As a result, it was confirmed that about 20% to 30% of elastic torsion of the torsion applied to the optical fiber wire remained.

In addition, although torsion (first elastic torsion) applied to the optical fiber wire by the first torsion application device may be continuously applied to the optical fiber wire in one direction, reversing the torsional direction to the clockwise direction and the counterclockwise direction periodically as described above, that is, applying alternately first direction torsion and second direction torsion, which is generated in the opposite direction to the direction of the first direction torsion, every predetermined length in the longitudinal direction of the optical fiber wire is more effective for suppressing the PMD increase caused by external factors.

In the case of reversing the torsional direction periodically as described above, it is preferable that the viscosity of the coating resin in a liquid state at the time of coating using a coating device be set within the range of 0.1 to 3 Pa·sec including each coating layer of the two-layer coat.

When the viscosity of the resin in a liquid state at the time of coating is less than 0.1 Pa·sec, it is difficult to coat the resin uniformly to obtain the coating layer with a uniform thickness since the viscosity is too low.

In this case, since the amount of change in the external diameter of the coat of the optical fiber wire exceeds ±2 μm, defective optical fiber wires may be produced.

On the other hand, when the viscosity of the resin in a liquid state at the time of coating exceeds 3 Pa·sec, the viscosity of the coating resin acts as a resistance against the transmission of torsion in the bare optical fiber from the first torsion application device to the upstream side of the first torsion application device.

As a result, since a phenomenon in which torsion is accumulated between the first torsion application device and the coating device is noticeable, the transmission of the torsion between the coat-curing device and the coating device also tends to be slow.

In this case, before torsion in a certain direction (for example, a clockwise direction) is reliably held by the coating layer between the coat-curing device and the coating device, torsion in the opposite direction (for example, a counterclockwise direction) is applied, so that the clockwise torsion is released. As a result, the amount of residual torsion after curing of the coating layer may be reduced or the torsion may be released almost completely.

Therefore, when reversing the torsional direction periodically, it is preferable to adjust the viscosity of the resin in a liquid state at the time of coating to fall within the above-described appropriate range.

In addition, when reversing the torsional direction periodically as described above, a torsion angle (angle obtained by accumulating the torsion angle in a fixed direction for continuous torsion, that is, an accumulated torsion angle) with respect to the longitudinal distance of the optical fiber wire can be drawn as a reverse torsion profile, for example, as a sinusoidal curve.

In addition, in the reverse torsion profile, the length on the optical fiber wire until twisting in a certain direction, for example, in the clockwise direction starts to apply torsion in the clockwise direction and then the direction of the torsion is reversed to apply torsion in the counterclockwise direction and the counterclockwise torsion ends is called an inversion period.

In other words, the inversion period of torsion may also be said to be the sum of the length of a section of continuous torsion in a certain direction and the length of a section which is adjacent to the section and in which torsion continues in the opposite direction, that is, the length of two continuous sections on the optical fiber wire.

In addition, the amplitude in the reverse torsion profile indicates the maximum value (maximum accumulated torsion angle) of the accumulated torsion angle within 1 inversion period.

In addition, generally, the waveform of the reverse torsion profile is preferably sinusoidal. However, the waveform of the reverse torsion profile may be triangular or trapezoidal and is not limited in particular.

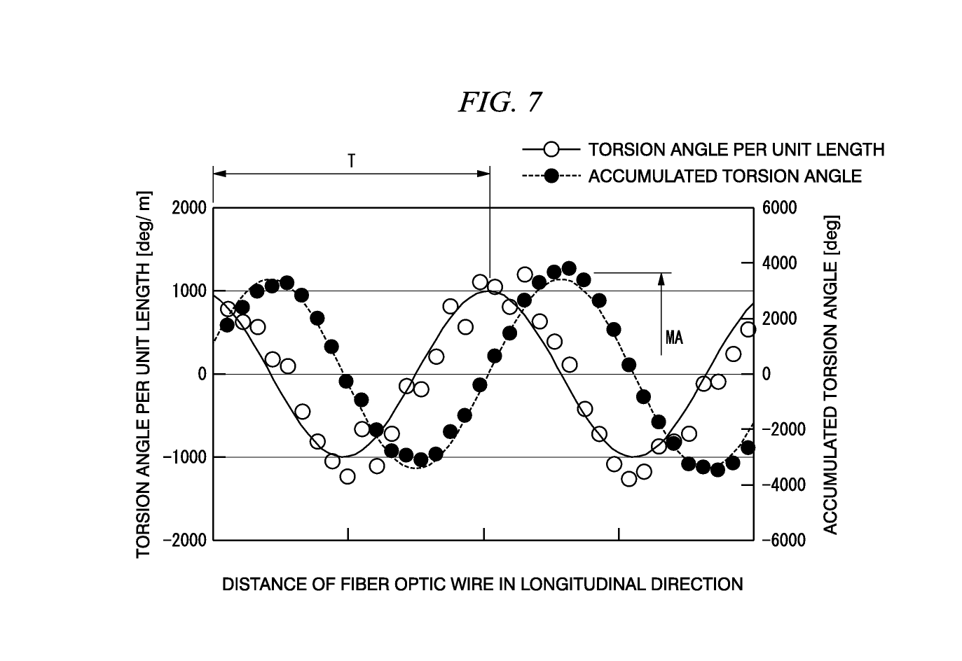

An example of the reverse torsion profile when adopting the sine wave is shown in FIG. 7.

In FIG. 7, a solid line indicates a transition of a torsion angle with respect to the longitudinal distance of an optical fiber wire (torsion angle per unit length), and a dotted line indicates a transition of an angle of accumulated torsion with respect to the longitudinal distance of the optical fiber wire.

Here, in the reverse torsion profile of the first elastic torsion applied by the first torsion application device, a torsion inversion period T1 is preferably set within a range of 5 to 10 m.

When the torsion inversion period T1 is less than 5 m, there is a possibility that clockwise torsion and counterclockwise torsion will be easily offset during the transmission.

On the other hand, when the torsion inversion period T1 exceeds 10 m, there is a possibility that the effect of suppressing the PMD increase caused by external factors will no longer be acquired if larger torsion is not applied.

Moreover, for the reverse torsion profile of the first elastic torsion when applying the first elastic torsion to the optical fiber wire in a state where the coating layer is not cured, it is preferable that the maximum amplitude MA (refer to FIG. 7) of the accumulated torsion angle be set within a range of 500×T1 to 4000×T1 (deg) in the relationship with the inversion period T1 of torsion.

When the maximum amplitude MA of the accumulated torsion angle is less than 500×T1 (deg), elastic torsion of a bare optical fiber portion which remains after external force on the optical fiber wire is removed is decreased. As a result, the effect of suppressing the PMD increase caused by external factors is reduced.

On the other hand, when the maximum amplitude MA of the accumulated torsion angle exceeds 4000×T1 (deg), stress applied from the bare optical fiber portion to the coating layer when external force on the optical fiber wire is removed is too large. As a result, peeling may occur between the bare optical fiber portion and the coating layer, or cracking may occur in the coating layer.

On the other hand, when the coating layer is cured and external force is removed, resilience acting in the release direction of the first elastic torsion and elastic repulsion of the coating layer against the resilience are in balance. Accordingly, a part of the first elastic torsion applied to the fiber remains and is held in a bare fiber portion.

For the reverse torsion profile in a state where a part of the first elastic torsion remains in the bare fiber portion as described above, it is preferable that the maximum amplitude of the accumulated torsion angle be set within a range of 100×T1 to 1200×T1 (deg) in the relationship with the inversion period T1 of torsion.

When the maximum amplitude MA of the accumulated torsion angle in this state is less than 100×T1 (deg), elastic torsion of the bare optical fiber portion is small. As a result, the effect of suppressing the PMD increase caused by external factors is reduced.

On the other hand, when the maximum amplitude MA of the accumulated torsion angle exceeds 1200×T1 (deg), stress applied from the bare optical fiber portion to the coating layer is too large. As a result, peeling may occur between the bare optical fiber portion and the coating layer, or cracking may occur in the coating layer.

In addition, the amount of residual elastic torsion, which is held in the bare optical fiber portion in the external force removal state after the coating layer is cured, can be measured according to the following method, for example.

That is, a) As a sample, the optical fiber wire manufactured by the method described above is extracted by about 1 m.

b) One end of the extracted sample is fixed, and the sample is hung in the vertical direction.

c) In a state where the torsion of the hung sample is released, the other end of the sample is fixed to a clip so as not to move, and the clip is fixed.

d) The coating layer of the sample (optical fiber wire) is removed (peeled) by 1 m in the above c) state.

e) The clip is released from the fixed state to make a free hanging state.

f) The rotation angle of the clip between the state where the clip is fixed in the above c) state and the state where the clip is released from the fixed state in the above e) state is measured.

g) The process of a) to f) is repeated multiple times when necessary in order to calculate the profile (distribution) of the rotation angle.

Here, the rotation angle when the optical fiber wire is hung and the coating layer is removed as described above and the fixation of the optical fiber wire is released as in f) in the state corresponds to the amount of elastic release of torsion, that is, the amount of torsion remaining and held in the bare wire.

Accordingly, the rotation angle measured by the above method is equivalent to the amount (deg/m) of residual elastic torsion per 1-m bare wire.

In addition, when the coating layer is cured and external force is removed, force (resilience) acting in the release direction of the first elastic torsion and force (elastic repulsion) based on elastic torsion of the coating layer are in balance and accordingly, the first elastic torsion remains and is held in the bare optical fiber portion. In this case, it is preferable that elastic torsion generated in the coating layer be set within a range of 1400 deg/m to 12800 deg/m.

When the elastic torsion of the coating layer is less than 1400 deg/m, the balance of coating characteristics, such as a Young's modulus or thickness of the coating layer, becomes worse. Accordingly, microbend characteristics, environmental resistance characteristics, handling efficiency, and the like become worse.

On the other hand, when the elastic torsion of the coating layer exceeds 12800 deg/m, the coating layer may be peeled off or crack.

Here, as described earlier, assuming that the amount of first elastic torsion applied to the optical fiber wire before the coating layer is cured is A (deg), the amount of elastic torsion, which remains in the bare optical fiber portion when the resilience of elastic torsion of the bare optical fiber portion and the elastic repulsion of the coating layer are in balance after the coating layer is cured and external force is removed, of the applied first elastic torsion is B (deg), and the inversion period of the first elastic torsion is T1 (m), elastic torsion of the coating layer is the amount of torsion (deg/m) applied by the following Expression (A−B)/(T1/4).

FIG. 8 shows another embodiment of the optical fiber wire manufacturing apparatus in the apparatus for manufacturing the optical fiber of the invention.

The optical fiber wire manufacturing apparatus shown in FIG. 8 has a configuration in which each of a coating device and a coat-curing device are provided at two places in order to manufacture an optical fiber wire having a coating layer with a two-layer structure.

That is, a primary coating device 20A is provided immediately below the cooling device 18, which cools and solidifies the bare optical fiber 16 drawn from the heating furnace for drawing 14, and a primary coat-curing device 22A is provided at the downstream side of the primary coating device 20A in order to coat and cure a first coating layer first.

In addition, a secondary coating device 20B and a secondary coat-curing device 22B are provided in order of 20B and 22B at the downstream side of the primary coat-curing device in order to coat and cure a second coating layer on the first coating layer.

Then, first elastic torsion is applied at the downstream side of the secondary coat-curing device 22B by the first torsion application device 26.

Also when coating and curing the coat layers at two separate places as described above in manufacturing the optical fiber wire having a coating layer with a two-layer structure, application of torsion, torsion holding, and residual torsion are the same as those in the case described on the basis of FIG. 1. In addition, the desired conditions are also the same as those described above.

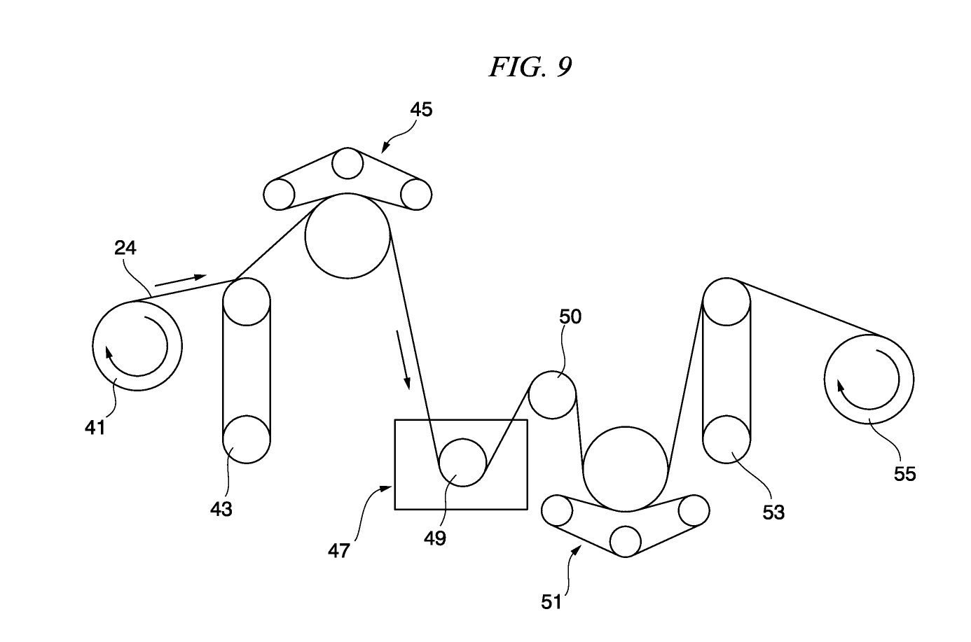

Next, FIG. 9 shows an example of a facility for applying the second elastic torsion to the optical fiber wire (optical fiber wire to which the first elastic torsion is applied) manufactured as described above using the second torsion application device. The process of applying the second elastic torsion and the preferable conditions of the second elastic torsion will be described with reference to FIG. 9.

In FIG. 9, for example, the optical fiber wire (wire to which the first elastic torsion is already applied) 24 manufactured by the optical fiber manufacturing apparatus 10 shown in FIG. 1 is wound on a feeding bobbin 41, and the optical fiber wire 24 is guided from the feeding bobbin 41 to a second torsion application device 47 through a feeding-side dancer roller 43 and a feeding-side capstan 45.

The second torsion application device 47 may be any of known devices. For example, it is preferable that a grooved roller 49, in which an optical fiber wire is wound on its outer periphery, rotate in the torsion application direction.

In addition, the torsion application device shown in FIGS. 2A and 2B or FIG. 3 may be appropriately applied as the first torsion application device.

The optical fiber wire 24 to which torsion has been applied by the second torsion application device 47 is wound by a winding bobbin 55 through a pulley 50, a winding side capstan 51, and a winding side dancer roller 53.

The second elastic torsion applied to the optical fiber wire by the second torsion application device described above is applied in a state where the resin coating layer of the optical fiber wire is already cured. Accordingly, unlike the first elastic torsion, the second elastic torsion is released (second elastic torsion disappears) if external force is completely removed.

That is, the second elastic torsion may be released in the subsequent process until the end-use form, such as an optical cable, is obtained.

However, in general, the second elastic torsion also remains slightly in the end-use form in many cases.

In addition, as already described, the first elastic torsion is held by the resin coating layer.

Therefore, also in the end-use form, about 20% or more of the first elastic torsion applied to the optical fiber wire remains reliably.

In addition, although torsion (second elastic torsion) applied to the optical fiber wire by the second torsion application device may be continuously applied to the optical fiber wire in one direction, reversing the torsional direction to the clockwise direction and the counterclockwise direction periodically as in the case of the first elastic torsion is more effective for suppressing the PMD increase caused by external factors.

In general, the waveform of the reverse torsion profile when torsion whose direction is reversed is applied as the second elastic torsion is preferably sinusoidal. However, the waveform of the reverse torsion profile may be triangular or trapezoidal and is not limited in particular.

Here, preferable values of an inversion period T2 and a torsion angle (maximum accumulated torsion angle=amplitude of the reverse torsion profile) of the reverse torsion profile of the second elastic torsion are selected in consideration of the relationship with the first elastic torsion.

Although the specific values will be described later, it is preferable to set the inversion period T2 of the second elastic torsion to be different from the inversion period T1 of the first elastic torsion.

In addition, there are a method of setting the inversion period T2 of the second elastic torsion shorter than the inversion period T1 of the first elastic torsion and a method of setting the inversion period T2 of the second elastic torsion longer than the inversion period T1 of the first elastic torsion.

From the point of view of the effect of PMD reduction, it is preferable that the inversion period of torsion be short.

From this point of view, setting the inversion period T2 of the second elastic torsion shorter than the inversion period T1 of the first elastic torsion may be considered.

On the other hand, from the point of view of ease of the release of torsion, the shorter the inversion period is, the easier is the release of torsion.

That is, in the process after the application of torsion, there is a correlation between the distance (free distance), by which an optical fiber wire is not in contact with a member such as a pulley which prevents the release of torsion, and the amount of release of torsion. That is, the more number of times of inversion within the free distance, the easier is the release of torsion.

Accordingly, the shorter the inversion period is, the easier is the release of torsion.

Here, the second elastic torsion is torsion which is not held by the resin coating layer unlike the first elastic torsion.

Accordingly, it is preferable to emphasize the ease of the release of torsion.

Therefore, in the invention, it is preferable to set the inversion period T2 of the second elastic torsion longer than the inversion period T1 of the first elastic torsion.

Next, for the first elastic torsion and the second elastic torsion, the preferable numerical range of the inversion period and the torsion angle (maximum accumulated torsion angle=amplitude of torsion profile) of the reverse torsion profile when reversing the direction of each torsion will be described on the basis of the relationship between the numerical range and the PMD suppression effect while referring to experimental results (FIGS. 10 to 16) of the inventors.

First, a PMD calculation method will be described.

A JME method was applied for the calculation of PMD.

Specifically, a method disclosed in the following document was applied.

B. L. Heffner, “Automated measurement of polarization mode dispersion using Jones Matrix Eigenanalysis”, “Photonics Technology Lett., vol. 4, no. 9, p. 1066, 1992 Here, in the Jones matrix used for calculation, approximation was used by defining that a plane wave propagates through a linear birefringence medium generated by lateral pressure of thin (Δz).

Assuming that the propagation constant of a plane wave with a certain frequency in the linear birefringence medium is βa(ω) and βb(ω), the Jones matrix for each layer and each frequency is expressed as follows.

$${J}_{i} ( ω ) = ( \begin{matrix}cos {θ}_{i} & - sin {θ}_{i} \\ sin {θ}_{i} & cos {θ}_{i}\end{matrix} ) ( \begin{matrix}{e}^{- i {β}_{a} ( ω ) Δ z} & 0 \\ 0 & {e}^{- i {β}_{b} ( ω ) Δ z}\end{matrix} ) ( \begin{matrix}cos {θ}_{i} & sin {θ}_{i} \\ - sin {θ}_{i} & cos {θ}_{i}\end{matrix} ) \qquad [ Expression 1 ]$$

Here, θ indicates the rotation angle of the plane of polarized light based on the optical rotation ability in the Δz caused by torsion.

Accordingly, the Jones matrix in the entire fiber length N×Δz may be calculated as follows.

$$J ( ω ) = {\prod }_{i = 1}^{N} {J}_{i} ( ω ) \qquad [ Expression 2 ]$$

Using the above calculation method, the PMD was calculated.

The calculation was performed under the conditions described later, and it was assumed that lateral pressure was applied in the fixed direction and the PMD change occurring at that time was calculated.

Here, birefringence caused by internal factors of the fiber is neglected because birefringence caused by external factors is generally 10 times or more greater than the birefringence caused by internal factors of the fiber.

Results after measuring the PMD using the above-described method while changing the conditions of applied elastic torsion are shown in FIGS. 10 to 16.

In addition, in FIGS. 10 to 16, the PMD change rate on the vertical axis indicates the rate of the PMD value on the condition that the PMD value when the external force (lateral pressure) is applied to the optical fiber wire in a state where no elastic torsion is applied (accordingly, a state where the amplitude of torsion is 0) is 1 and the PMD value in a state where no external force (lateral pressure) is applied to the optical fiber wire is 0.

First, for the PMD change rate in a state where one type of elastic torsion is applied, the dependence of elastic torsion on the period and the amplitude is shown in FIG. 10.

In addition, FIG. 10 shows measurement results in a state where the type of elastic torsion is not particularly limited to either the first torsion or the second torsion and the applied elastic torsion is not released at all.

Here, the reverse torsion profile shown in FIG. 10 is assumed to be a sine wave, the inversion period of torsion is changed in four steps of 5 m, 10 m, 20 m, and 30 m, and the PMD change according to the reverse torsion amplitude (maximum accumulated torsion angle) in each of the periods described above is shown.

This result shows that the PMD tends to decrease at shorter inversion periods as the inversion period of torsion becomes shorter.

For example, in the case of the period of 30 m, the amplitude required for the PMD to decrease is large.

In addition, from FIG. 10, it is also apparent that the PMD reduction rate varies according to the amplitude change.

This result shows that the PMD change caused by the slight difference in the release of torsion is large.

In other words, this implies that quality compensation regarding the PMD is not possible if strict control is not performed even for the release of elastic torsion.

FIGS. 11 to 13 show the change rate in the PMD of an optical fiber wire to which two types of elastic torsion (first and second elastic torsion) are applied.

That is, in a case where the inversion period T1 of the first elastic torsion is 5 m and the amplitude is 2500 deg (residual amplitude is 500 deg), the PMD change rate when the inversion period T2 of the second elastic torsion is set to 5 m, 10 m (5 m×2), 15 m (5 m×3), and 20 m (5 m×4) and the amplitude of the second elastic torsion is changed is shown in FIG. 11.

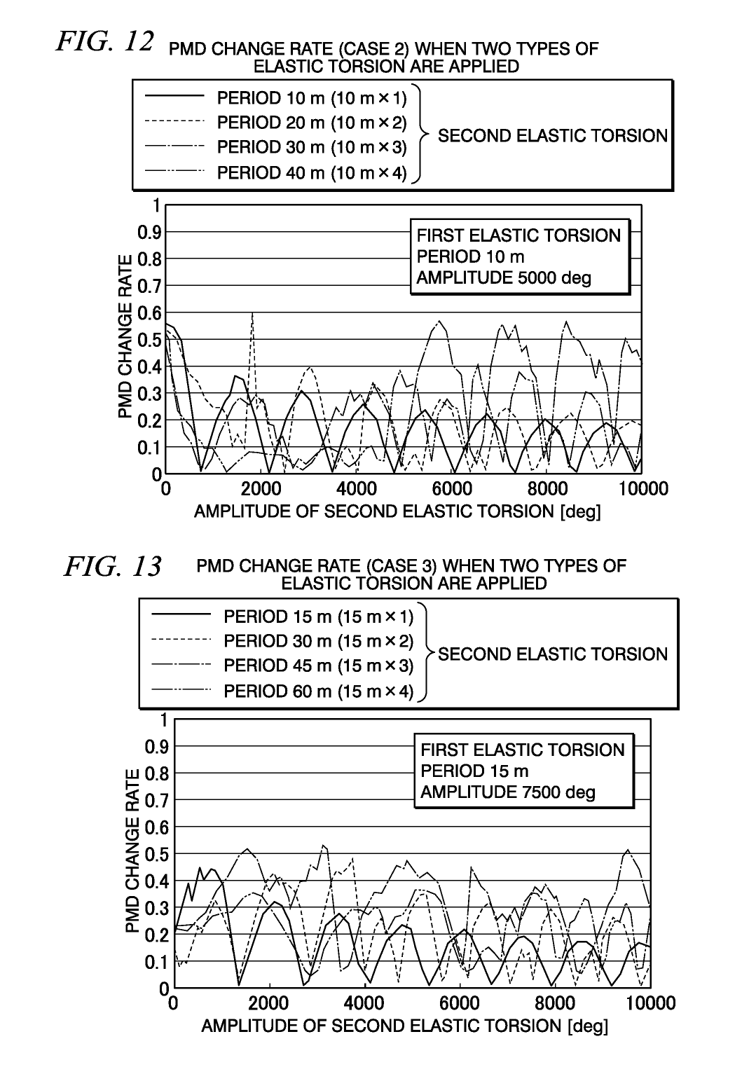

In addition, in a case where the inversion period T1 of the first elastic torsion is 10 m and the amplitude is 5000 deg (residual amplitude is 1000 deg), the PMD change rate when the period T2 of the second elastic torsion is set to 10 m (10 m×1), 20 m (10 m×2), 30 m (10 m×3), and 40 m (10 m×4) and the amplitude of the second elastic torsion is changed is shown in FIG. 12.

In addition, in a case where the period T1 of the first elastic torsion is 15 m and the amplitude is 7500 deg (residual amplitude is 1500 deg), the PMD change rate when the period T2 of the second elastic torsion is set to 15 m (15 m×1), 30 m (15 m×2), 45 m (15 m×3), and 60 m (15 m×4) and the amplitude of the second elastic torsion is changed is shown in FIG. 13.

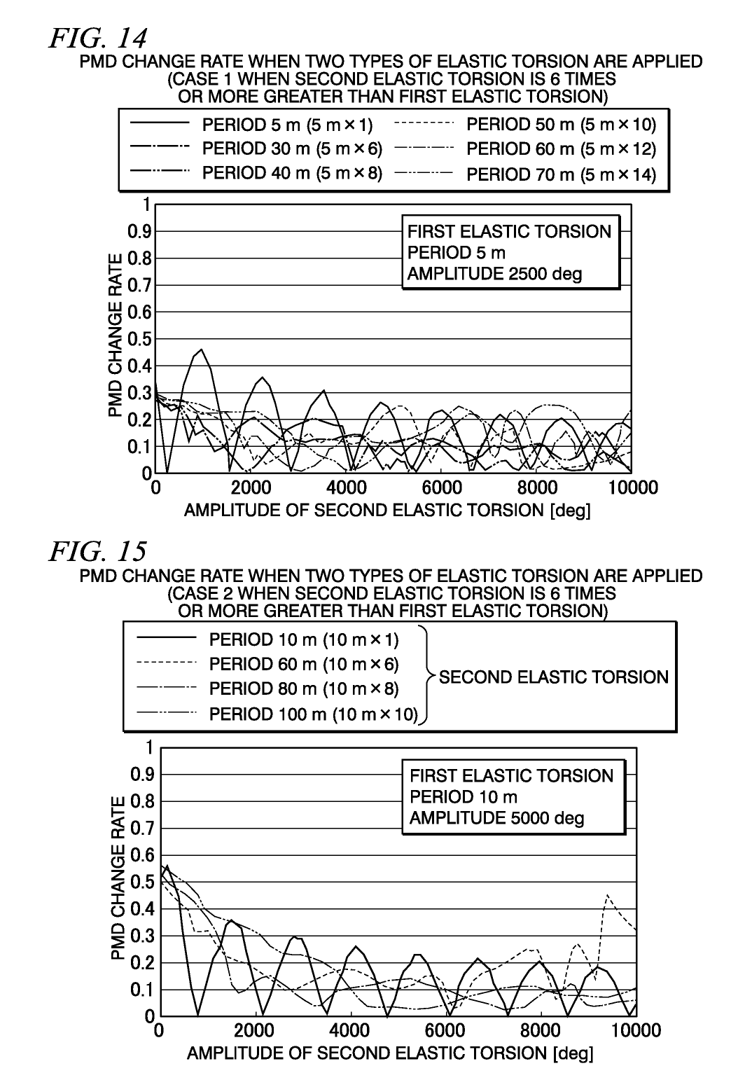

In addition, FIGS. 14 to 16 show a case where the period T2 of the second elastic torsion is the same as the period T1 of the first elastic torsion (×1) and a case where the period T2 of the second elastic torsion is 6 times (×6) or more greater than the period T1 of the first elastic torsion.

That is, FIG. 14 shows a case where the period T1 of the first elastic torsion is 5 m while the period T2 of the second elastic torsion is 5 m (5 m×1), 30 m (5 m×6), 40 m (5 m×8), 50 m (5 m×10), 60 m (5 m×12), and 70 m (5 m×14).

In addition, FIG. 15 shows a case where the period T1 of the first elastic torsion is 10 m while the period T2 of the second elastic torsion is 10 m (10 m×1), 60 m (10 m×6), 80 m (10 m×8), and 100 m (10 m×10).

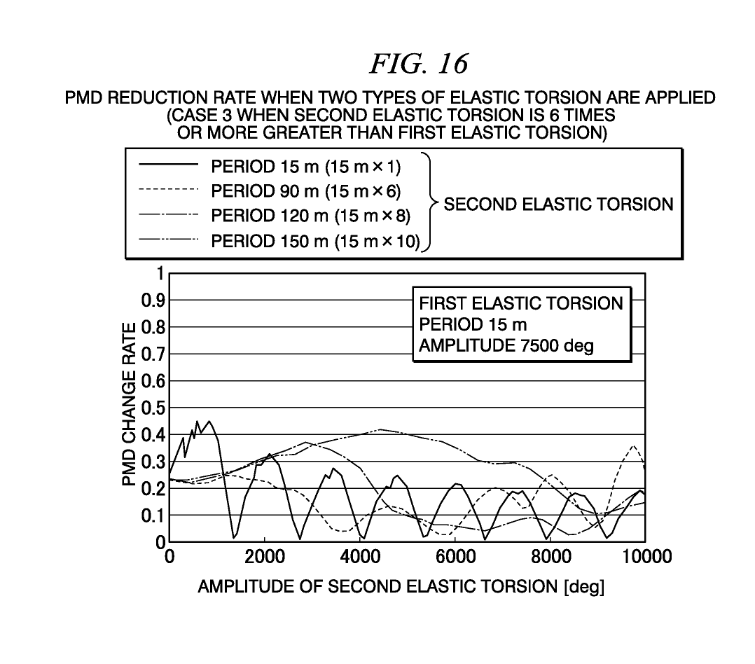

In addition, FIG. 16 shows a case where the period T1 of the first elastic torsion is 15 m while the period T2 of the second elastic torsion is 15 m (15 m×1), 90 m (15 m×6), 120 m (15 m×8), and 150 m (15 m×10).

From these results, following findings was obtained.

A: Due to the influence of the residual first elastic torsion, the PMD change rate does not become 1 even if the second elastic torsion is completely released. Accordingly, the PMD suppression effect can be obtained.

B: In addition, the PMD change rate is reduced by setting the inversion period T2 of the second elastic torsion to 4 times or more (20 m or more in the case of FIG. 11 and 40 m or more in the case of FIG. 12) the inversion period T1 of the first elastic torsion and setting the amplitude of the second elastic torsion to 500 to 5000 deg. As a result, the PMD suppression effect becomes large.

C: In addition, when the amplitude of the second elastic torsion is set to 5000 deg or more, the tendency in which the value of the PMD change rate decreases, that is, the tendency in which the PMD suppression effect becomes large can no longer be recognized.

D: Moreover, from FIG. 13, in the case where the period T1 of the first elastic torsion is 15 m, the PMD change rate is not reduced if the period T2 of the second elastic torsion is 60 m or more. Accordingly, the PMD suppression effect is not obtained.

E: In addition, it can be seen that the PMD change rate is reduced, that is, the PMD reduction effect is increased by setting the period T2 of the second elastic torsion to 8 times or less (40 m or less in the case of FIG. 14 and 80 m or less in the case of FIG. 15) the period T1 (5 m in the case of FIG. 14 and 10 m in the case of FIG. 15) of the first elastic torsion and setting the amplitude of the second elastic torsion to 500 to 5000 deg.

From the above, the following conditions were confirmed.

That is, it is preferable that the period T1 of the reverse torsion of the first elastic torsion fall within the range of 5 to 10 m.

It is preferable that the amplitude (maximum accumulated torsion angle) of the first elastic torsion fall within the range of 500×T1 to 4000×T1 (deg) at the time of torsion application.

It is preferable that the amount of residual first elastic torsion fall within the range of 100×T1 to 1200×T1 (deg).

In addition, for the second elastic torsion when the conditions of the first elastic torsion are in the above ranges, it was confirmed that the period T2 of the reverse torsion preferably fell within the range of 4 to 8 times the period T1 of the first elastic torsion and the amplitude (maximum accumulated torsion angle) preferably fell within the range of 300 to 5000 deg at the time of torsion application.

Hereinafter, experimental examples of the invention will be described together with comparative examples.

In addition, the following experimental examples are examples for clarifying the operations and effects of the invention, and the technical scope of the invention is not limited by the conditions described in these experimental examples.

### EXPERIMENTAL EXAMPLES

### First Experimental Example

An optical fiber wire was manufactured by applying the first elastic torsion and the second elastic torsion to a quartz glass-based optical fiber wire according to the above-described method of the invention in order to obtain a two-layer coating structure, which has the characteristics of a typical single-mode fiber.

The apparatus shown in FIG. 1 was used as an optical fiber wire manufacturing apparatus, the device shown in FIG. 3 was used as a first torsion application device in the manufacturing apparatus, and the apparatus shown in FIG. 9 was used as a second torsion application device in the manufacturing apparatus.

The drawing speed from the optical fiber preform (fiber drawing speed) was set to 2000 mm/min, and a two-layer simultaneous coating method (wet on wet method) for coating two kinds of coating resin at one place was applied to the coating device.

UV-curable urethane acrylate-based resin (Young's modulus at the time of curing was 0.5 MPa) was used as a resin (primary material) of the first coating layer, and UV-curable urethane acrylate-based resin (Young's modulus at the time of curing was 1000 MPa) was used as a resin (secondary material) of the second coating layer.

In addition, the viscosity of liquid resin at the time of coating of both the above materials was adjusted to 1 Pa·sec, and the liquid resin was coated by the coating device and then cured by a UV lamp as the coat-curing device.

The first elastic torsion was applied immediately after the process of curing the coating resin using the coat-curing device.

In addition, at the upstream side of the first torsion application device, fiber drawing was performed in a state where there was no physical contact with the optical fiber wire except for the coating resin.

Here, the profile of torsion in a longitudinal direction of the optical fiber wire, which was applied to the optical fiber wire by the first torsion application device, was a sine wave which had a periodically reversed torsional direction, and the swing angle and the swing speed of the first torsion application device were set such that the period T1 became 5 m and the maximum amplitude MA of the accumulated torsion angle became 2500 deg (500×5).

The optical fiber wire after passing the first torsion application device was picked up by a pickup device through a guide pulley and was wound by a winding device through a dancer pulley. As a result, an optical fiber wire in which first elastic torsion (first twist) was applied to the bare optical fiber portion was obtained.

In addition, in the obtained optical fiber wire, the diameter of the bare wire was 125 μm, the primary diameter of the external diameter of the coat (external diameter of the first coating layer) was 200 μm, and the secondary diameter (external diameter of the second coating layer) was 250 μm.

Then, using the second elastic torsion application device shown in FIG. 9, the second elastic torsion was applied to the optical fiber wire obtained through the above-described process.

The reverse torsion profile of the second elastic torsion was a sine wave whose rotation direction changed, and the swing angle and the speed of the second elastic torsion application device were set such that the period T2 became 20 m and the maximum amplitude became 500 deg.

Side pressure was intentionally applied to optical fiber wires by rewinding the 1000-m optical fiber wire sample obtained through the above-described process around a 400 mm steel bobbin with a winding tension of 200 gf and with one layer so that the fibers did not overlap each other.

That is, optical fiber wires under the conditions where the PMD was likely to occur due to external factors were manufactured.

After the rewinding, torsion of the fiber was measured. For the second elastic torsion applied through the above-described process, the period T2 was not changed at 20 m, and the maximum amplitude was 400 deg. Accordingly, it was confirmed that 20% of the applied second elastic torsion was released.

In addition, for the bare optical fiber to which the first elastic torsion was applied, it was confirmed that the maximum amplitude of elastic torsion, which remained and was held in the bare optical fiber in a state where the external force was removed after curing of the coating layer, was 500 deg as a result of removing the coating layer of the optical fiber wire, from which the external force was removed, and measuring the rotation angle of the bare optical fiber after removing the coating layer according to the measurement method described above.

Then, the fiber was left unattended for 1 hour or more in order to stabilize the temperature of the fiber, and then the PMD was measured.

Additionally, the PMD was measured using the HP8509B made by Hewlett Packard and the JME method (Jones Matrix Eigenanalysis method).

The measured wavelength was 1510 to 1600 nm, and a scan was performed every 2 nm.

As a result, the PMD value (PMD1) in a state where the lateral pressure of rewinding by tension application winding was applied was 0.05 ps/√km, which was very small.

Then, rewinding was performed again with the same winding tension as in the process described above.

After the rewinding, torsion was measured. For the second elastic torsion, the period T2 was not changed at 20 m, and the maximum amplitude was 300 deg. Accordingly, it was confirmed that about 20% of the second elastic torsion was released.

In addition, for the first elastic torsion applied to the bare optical fiber, it was confirmed that there was no change.

After the fiber was left unattended in order to stabilize the temperature of the fiber, the PMD was measured. As a result, the PMD value (PMD value in a state where the lateral pressure of rewinding by the second tension application was applied=PMD2) was 0.10 ps/√km, which was very small.

In addition, rewinding was performed again with the same winding tension as in the process described above.

After the rewinding, torsion was measured. For the second elastic torsion, the period T2 was not changed at 20 m, and the maximum amplitude was 250 deg. Accordingly, it was confirmed that about 20% of the second elastic torsion was released.

In addition, for the first elastic torsion applied to the bare optical fiber, it was confirmed that there was no change.

After the fiber was left unattended in order to stabilize the temperature of the fiber, the PMD was measured. As a result, the PMD value (PMD value in a state where the lateral pressure of rewinding by the third tension application was applied=PMD3) was 0.13 ps/√km, which was very small.

Finally, the second elastic torsion applied to the optical fiber was intentionally released by securing a 10-m free length (distance by which the optical fiber was not in contact with a pulley or the like) and rewinding the optical fiber wire using the rewinding device.

Then, rewinding was performed again with the same winding tension as in the above-described process, and the PMD was measured. As a result, the PMD value (PMD value after the second elastic torsion was released=PMD4) was 0.18 ps/√km.

From the above, it could be seen that, among the PMD obtained by the four measurements described above, the highest PMD was PMD4 in a state where the second elastic torsion was released and only the first elastic torsion remained, and the PMD was low in cases where even the slight second elastic torsion remained (PMD1 to PMD3).

In addition, the standard deviation of the results of the four PMD measurements was calculated, and the calculation result was 0.05 ps/√km. Accordingly, it could be seen that the variability was very small.

### First Comparative Example

An optical fiber wire was manufactured using the same method as in the first experimental example except that first elastic torsion was not applied.

In addition, each PMD value (PMD1 to PMD4) in a state where lateral pressure was intentionally applied was measured in the same manner as in the first experimental example.

As a result, the PMD value of the optical fiber wire sample in a stage where torsion was not completely released was PMD1=0.05 (maximum amplitude of residual torsion was 2000 deg), PMD2=0.21 (maximum amplitude of residual torsion was 1600 deg), and PMD3=0.23 (maximum amplitude of residual torsion was 1250 deg).

In addition, the PMD4 of the optical fiber wire sample when the second elastic torsion was completely released was 0.55, and the standard deviation was 0.21 ps/√km.

From the above, it could be seen that PMD1 to PMD3 were smaller than PMD4 after the release of torsion, but the standard deviation was large.

The reason for this result is that, since the first elastic torsion is not applied in the case of the first comparative example, there is no residual torsion in the fiber after the release of torsion.

### Second Experimental Example

An optical fiber wire was manufactured by applying the first elastic torsion and the second elastic torsion to a quartz glass-based optical fiber wire with a two-layer coating structure, which has the characteristics of a typical single-mode fiber, according to the above-described method of the invention.

The apparatus shown in FIG. 8 was used as an optical fiber wire manufacturing apparatus, the device shown in FIG. 3 was used as a first torsion application device in the manufacturing apparatus, and the apparatus shown in FIG. 9 was used as a second torsion application device in the manufacturing apparatus.

The drawing speed (fiber drawing speed) from the optical fiber preform was set to 1500 mm/min.

In addition, a method of coating different coating resins at two places (wet on dry method) as shown in FIG. 8 was applied as a coating and curing method.

A UV-curable urethane acrylate-based resin (Young's modulus at the time of curing was 1.0 MPa) was used as a resin (primary material) of the first coating layer, and a UV-curable urethane acrylate-based resin (Young's modulus at the time of curing was 500 MPa) was used as a resin (secondary material) of the second coating layer.

In addition, for the viscosity of the coating resin at the time of coating of the above materials, the viscosity of the primary material was adjusted to 3 Pa·sec and the viscosity of the secondary material was adjusted to 0.1 Pa·sec.

The optical fiber wire was coated with a liquid-state primary material by the primary coating device 20A and then was cured by a UV lamp as the primary coat-curing device 22A. Then, the optical fiber wire was coated with a secondary material by the secondary coating device 20B and then was cured by a UV lamp as the secondary coat-curing device 22B.

The first elastic torsion was applied immediately after the process of curing the secondary material by the secondary coat-curing device 22B.

In addition, at the upstream side of the first torsion application device 26, fiber drawing was performed in a state where there was no physical contact with the optical fiber wire except for the coating resin.

Here, the profile of the first elastic torsion in a longitudinal direction of the optical fiber, which was applied to the optical fiber wire 24 by the first torsion application device 26, was a triangular wave which had a periodically reversed torsional direction, and the swing angle and the swing speed of the first torsion application device were set such that the period T1 became 5 m and the maximum amplitude MA of the accumulated torsion angle became 20000 deg.

The optical fiber wire 24 after passing the first torsion application device 26 was picked up by a pickup device (not shown) through the guide pulley 28 and was wound by a winding device through a dancer pulley. As a result, an optical fiber in which elastic torsion (twist) was given to a bare optical fiber wire portion was obtained.

In the obtained optical fiber wire, the diameter of the bare wire was 125 μm, the primary diameter of the external diameter of the coat (external diameter of the first coating layer) was 190 μm, and the secondary diameter (external diameter of the second coating layer) was 240 μm.

Then, the optical fiber wire was rewound by a rewinding device while securing a distance (free length) of 10 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 20 m and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in a state where the second torsion was not completely released was PMD1=0.08 ps/√km (maximum amplitude of residual torsion was 4000 deg), PMD2=0.04 (maximum amplitude of residual torsion was 3200 deg), and PMD3=0.06 (maximum amplitude of residual torsion was 2500 deg).

In addition, the PMD value of the optical fiber wire sample when the second elastic torsion was completely released was PMD4=0.16, and the standard deviation was 0.05 ps/√km.

From the above, it could be seen that, among the PMD obtained by the four measurements described above, the highest PMD was PMD4 in a state where the second elastic torsion was completely released and only the first elastic torsion remained, and the PMD was low in cases where even the slight second elastic torsion remained (PMD1 to PMD3).

In addition, the standard deviation of the results of the four PMD measurements was calculated, and the calculation result was 0.05 ps/√km. Accordingly, it could be seen that the variability was very small.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 4000 deg as a result of removing the coating layer of the optical fiber wire, from which the external force was removed, and measuring the rotation angle of the bare optical fiber after removing the coating layer according to the measurement method described above.

### Third Experimental Example

An optical fiber wire with a two-layer coating structure was manufactured by applying the first elastic torsion and the second elastic torsion in the same manner as in the second experimental example.

For the viscosity of the coating resin (in a liquid state) at the time of coating, the viscosity of the primary material was adjusted to 0.1 Pa·sec and the viscosity of the secondary material was adjusted to 3 Pa·sec.

The profile of the first elastic torsion in a longitudinal direction of the optical fiber wire, which was applied to the optical fiber wire by the first torsion application device, was a trapezoidal wave which had a periodically reversed torsional direction, and the swing angle and the swing speed of the first torsion application device were set such that the period T1 became 10 m and the maximum amplitude MA of the accumulated torsion angle became 5000 deg (500×10).

The optical fiber wire after passing the first torsion application device was picked up by a pickup device and was wound by a winding device through a dancer pulley. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 180 μm, and the secondary diameter was 260 μm.

Then, the optical fiber wire was rewound by a rewinding device while securing a distance (free length) of 20 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 40 m and the maximum amplitude became 300 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.10 ps/√km (maximum amplitude of residual torsion was 240 deg), PMD2=0.14 (maximum amplitude of residual torsion was 200 deg), and PMD3=0.20 (maximum amplitude of residual torsion was 160 deg).

In addition, the PMD4 of the optical fiber wire sample when the second elastic torsion was completely released was 0.28, and the standard deviation was 0.08 ps/√km.

From the above, it could be seen that, among the PMD obtained by the four measurements described above, the highest PMD was PMD4 in a state where the second elastic torsion was completely released and only the first elastic torsion remained, and the PMD was low in cases where even the slight second elastic torsion remained (PMD1 to PMD3).

In addition, the standard deviation of the results of the four PMD measurements was 0.08 ps/√km. Accordingly, it could be seen that the variability was very small.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 1000 deg as a result of removing the coating layer of the optical fiber wire, from which the external force was removed, and measuring the rotation angle of the bare optical fiber after removing the coating layer according to the measurement method described above.

### Fourth Experimental Example

An optical fiber wire with a two-layer coating structure was manufactured by applying the first elastic torsion and the second elastic torsion in the same manner as in the third experimental example.

For the viscosity of the coating resin (in a liquid state) at the time of coating, the viscosity of the primary material was adjusted to 0.1 Pa·sec and the viscosity of the secondary material was adjusted to 3 Pa·sec, in the same manner as in the third experimental example.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the first torsion application device were set such that the period T1 became 10 m and the maximum amplitude MA of the accumulated torsion angle became 40000 deg.

The optical fiber wire after passing the first torsion application device was picked up by a pickup device and was wound by a winding device through a dancer pulley. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 200 μm, and the secondary diameter was 250 μm.

Then, the optical fiber wire was rewound by a rewinding device while securing a distance (free length) of 20 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 40 m and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.04 ps/√km (maximum amplitude of residual torsion was 4000 deg), PMD2=0.05 (maximum amplitude of residual torsion was 3200 deg), and PMD3=0.03 (maximum amplitude of residual torsion was 2500 deg).

In addition, the PMD4 of the optical fiber wire sample when the second elastic torsion was completely released was 0.12, and the standard deviation was 0.04 ps/√km.

From the above, it could be seen that, among the PMD obtained by the four measurements described above, the highest PMD was PMD4 in a state where the second elastic torsion was completely released and only the first elastic torsion remained, and the PMD was low in cases where even the slight second elastic torsion remained (PMD1 to PMD3).

In addition, the standard deviation of the results of the four PMD measurements was 0.04 ps/√km. Accordingly, it could be seen that the variability was very small.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 8000 deg as a result of removing the coating layer of the optical fiber wire, from which the external force was removed, and measuring the rotation angle of the bare optical fiber after removing the coating layer according to the measurement method described above.

### Second Comparative Example

An optical fiber wire with a two-layer coating structure was manufactured by applying elastic torsion (twist) in the same manner as in the first experimental example.

For the viscosity of the coating resin at the time of coating, both the viscosity of the primary material and the viscosity of the secondary material were adjusted to 1 Pa·sec.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the torsion application device were set such that the period T1 became 5 m and the maximum amplitude MA of the accumulated torsion angle became 2500 deg.

The optical fiber wire after passing the torsion application device was picked up by a pickup device and was wound through a dancer pulley by a winding device. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 200 μm, and the secondary diameter was 250 μm.

Then, the optical fiber wire was rewound by a rewinding device while securing a distance (free length) of 10 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 5 m and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.04 ps/√km (maximum amplitude of residual torsion was 4000 deg), PMD2=0.20 (maximum amplitude of residual torsion was 2500 deg), and PMD3=0.24 (maximum amplitude of residual torsion was 1000 deg).

In addition, the PMD4 of the optical fiber wire sample when the second elastic torsion was completely released was 0.18, and the standard deviation was 0.09 ps/√km.

From the above, among the PMD obtained by the four measurements described above, the highest PMD was not PMD4 in a state where the second elastic torsion was completely released and only the first elastic torsion remained but the PMD3. Therefore, it could be seen that the PMD was high even though the second elastic torsion remained.

This is because, when the period T1 of the first elastic torsion is the same as the period T2 of the second elastic torsion, the final reverse torsion profile is a simple sum of the residual amplitude of the first elastic torsion and the residual amplitude of the second elastic torsion and the PMD reduction rate periodically changes like the waveform in the case of the 5 m period shown in FIG. 10.

That is, when the residual amplitude of the first elastic torsion does not remain at the peak position of the fluctuation cycle of the PMD change rate, the PMD may be increased by applying the second elastic torsion.

Therefore, it can be said that it is of no value to apply the second elastic torsion separately from the first elastic torsion.

In addition, the standard deviation of the results of the four PMD measurements described above is calculated, and the calculation result is 0.09 ps/√km. That is, the variability is small. However, for the above reason, it is thought that the PMD value will oscillate if the PMD with respect to residual torsion is measured more finely. In this case, it is understood that the variability will also increase.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 500 deg as a result of removing the coating layer of the optical fiber wire, from which the external force was removed, and measuring the rotation angle of the bare optical fiber after removing the coating layer according to the measurement method described above.

### Third Comparative Example

An optical fiber wire with a two-layer coating structure was manufactured by applying elastic torsion in the same manner as in the first experimental example.

For the viscosity of the coating resin at the time of coating, both the viscosity of the primary material and the viscosity of the secondary material were adjusted to 1 Pa·sec.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the torsion application device were set such that the period T1 became 5 m and the maximum amplitude MA of the accumulated torsion angle became 2500 deg.

The optical fiber wire after passing the torsion application device was picked up by a pickup device and was wound through a dancer pulley by a winding device. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 200 μm, and the secondary diameter was 250 μm.

Then, the optical fiber wire was rewound by a rewinding device while securing a distance (free length) of 10 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The reverse torsion profile of the second elastic torsion was a sine wave whose rotation direction changed, and the swing angle and the speed of the second elastic torsion application device were set such that the period T2 became 10 m and the maximum amplitude became 4000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.10 ps/√km (maximum amplitude of residual torsion was 4000 deg), PMD2=0.05 (maximum amplitude of residual torsion was 3200 deg), and PMD3=0.20 (maximum amplitude of residual torsion was 2500 deg), and the PMD4 of the optical fiber wire sample in a stage where the second elastic torsion was completely released was 0.18 and the standard deviation was 0.07 ps/√km.

From the above, among the PMD obtained by the four measurements described above, the highest PMD was not PMD4 in a state where the second elastic torsion was completely released and only the first elastic torsion remained but the PMD3. Therefore, it could be seen that the PMD was high even though the second elastic torsion remained.

That is, as in the second comparative example, it can be said that it is of no value to apply the second elastic torsion when the period T2 of the second elastic torsion is less than 4 times the period T1 of the first elastic torsion.

In addition, the standard deviation of the results of the four PMD measurements was calculated, and the calculation result was 0.07 ps/√km. That is, the variability was very small. However, for the above reason, it is thought that the PMD value will oscillate if the PMD with respect to residual torsion is measured more finely. In this case, it is thought that the variability will also increase.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 500 deg as a result of removing the coating layer of the optical fiber wire, from which the external force was removed, and measuring the rotation angle of the bare optical fiber after removing the coating layer according to the measurement method described above.

### Fourth Comparative Example

An optical fiber wire with a two-layer coating structure was manufactured by applying elastic torsion in the same manner as in the first experimental example.

As the viscosity of the coating resin at the time of coating, the viscosity of the primary material was adjusted to 3.5 Pa·sec and the viscosity of the secondary material was adjusted to 0.5 Pa·sec.

The profile of the first elastic torsion in a longitudinal direction of the optical fiber, which was applied to the optical fiber wire by the first torsion application device, was a triangular wave which had a periodically reversed torsional direction, and the swing angle and the swing speed of the torsion application device were set such that the period T1 became 5 m and the maximum amplitude MA of the accumulated torsion angle became 2500 deg.

The optical fiber wire after passing the torsion application device was picked up by a pickup device and was wound through a dancer pulley by a winding device. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 180 μm, and the secondary diameter was 260 μm.

Then, the optical fiber wire was rewound by a rewinding device while securing a distance (free length) of 10 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The reverse torsion profile of the second elastic torsion was a sine wave whose rotation direction changed, and the swing angle and the speed of the second elastic torsion application device were set such that the period T2 became 20 m and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.05 ps/√km (maximum amplitude of residual torsion was 4000 deg), PMD2=0.12 (maximum amplitude of residual torsion was 3200 deg), and PMD3=0.15 (maximum amplitude of residual torsion was 2500 deg).

In addition, the PMD4 of the optical fiber wire sample when the second elastic torsion was completely released was 0.35, and the standard deviation was 0.13 ps/√km.

As described above, in the fourth comparative example, since the viscosity of the primary resin when applying the first elastic torsion was high, torsion applied to glass before ultraviolet curing was offset and residual torsion was reduced accordingly.

For this reason, the PMD4 after the release of the second elastic torsion was increased.

In addition, the standard deviation was large due to the influence of the increase in the PMD4. Therefore, an undesirable result was obtained.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 250 deg as a result of removing the coating layer of the optical fiber wire, from which the external force was removed, and measuring the rotation angle of the bare optical fiber after removing the coating layer according to the measurement method described above.

### Fifth Comparative Example

An optical fiber wire with a two-layer coating structure was manufactured by applying elastic torsion (twist) in the same manner as in the first experimental example.

For the viscosity of the coating resin at the time of coating, the viscosity of the primary material was adjusted to 2 Pa·sec and the viscosity of the secondary material was adjusted to 0.05 Pa·sec.

The profile of the first elastic torsion in a longitudinal direction of the optical fiber wire, which was applied to the optical fiber wire by the first torsion application device, was a triangular wave which had a periodically reversed torsional direction, and the swing angle and the swing speed of the torsion application device were set such that the period T1 became 5 m and the maximum amplitude MA of the accumulated torsion angle became 2500 deg.

The optical fiber wire after passing the torsion application device was picked up by a pickup device and was wound through a dancer pulley by a winding device. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 180 μm, and the average of the secondary diameter was 260 μm However, a change in the secondary diameter was 5 μm, which was very large.

This is because the resin viscosity of the secondary material was too low and accordingly, coating was not stable.

For this reason, application of the second elastic torsion and evaluation of the PMD were not performed.

### Sixth Comparative Example

An optical fiber wire with a two-layer coating structure was manufactured by applying elastic torsion in the same manner as in the first experimental example.

For the viscosity of the coating resin at the time of coating, both the viscosity of the primary material and the viscosity of the secondary material were adjusted to 1 Pa·sec.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the torsion application device were set such that the period T1 became 3 m and the maximum amplitude MA of the accumulated torsion angle became 1500 (500×3) deg.

The optical fiber wire after passing the torsion application device was picked up by a pickup device and was wound through a dancer pulley by a winding device. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 200 μm, and the secondary diameter was 250 μm.

Then, the optical fiber wire was rewound by a rewinding device while securing a distance (free length) of 10 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The twist profile of the second elastic torsion was a sine wave whose rotation direction changed, and the swing angle and the speed of the second elastic torsion application device were set such that the period T2 became 30 m and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.28 ps/√km (maximum amplitude of residual torsion was 4000 deg), PMD2=0.30 (maximum amplitude of residual torsion was 3200 deg), and PMD3=0.38 (maximum amplitude of residual torsion was 2500 deg).

In addition, the PMD4 of the optical fiber wire sample when the second elastic torsion was completely released was 0.40, and the standard deviation was 0.13 ps/√km.

In the sixth comparative example, since the period T1 of the first elastic torsion was short, the twist applied to glass before ultraviolet curing was offset and residual torsion was reduced accordingly.

For this reason, the PMD4 after the release of the second elastic torsion was increased.

Due to this influence, the effect of the application of the first elastic torsion was reduced. Accordingly, it was apparent that this was not preferable.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 100 deg as a result of removing the coating layer of the optical fiber wire, from which the external force was removed, and measuring the rotation angle of the bare optical fiber after removing the coating layer according to the measurement method described above.

### Seventh Comparative Example

An optical fiber wire with a two-layer coating structure was manufactured by applying elastic torsion in the same manner as in the first experimental example.

For the viscosity of the coating resin at the time of coating, both the viscosity of the primary material and the viscosity of the secondary material were adjusted to 1 Pa·sec.

The reverse torsion profile of elastic torsion in a longitudinal direction of the optical fiber wire, which was applied to the optical fiber wire by the first torsion application device, was a sine wave which had a periodically reversed torsional direction, and the swing angle and the swing speed of the torsion application device were set such that the period T1 became 5 m and the maximum amplitude MA of the accumulated torsion angle became 25000 deg (20000 (4000×5) or more).

The optical fiber wire after passing the torsion application device was picked up by a pickup device and was wound through a dancer pulley by a winding device. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 200 μm, and the secondary diameter was 250 μm.

Then, the optical fiber wire was rewound by a rewinding device while securing a distance (free length) of 10 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The twist profile of the second elastic torsion was a sine wave whose rotation direction changed, and the swing angle and the speed of the second elastic torsion application device were set such that the period T2 became 20 m and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.04 ps/√km (maximum amplitude of residual torsion was 4000 deg), PMD2=0.10 (maximum amplitude of residual torsion was 3200 deg), and PMD3=0.12 (maximum amplitude of residual torsion was 2500 deg).

The PMD4 of the optical fiber wire sample when the second elastic torsion was completely released was 0.12, and the standard deviation was 0.03 ps/√km. Accordingly, the PMD suppression effect was satisfactory.

However, when the coat was observed after putting the optical fiber wire obtained in the seventh comparative example into the constant temperature bath and performing a heat cycle test of −40° C. to +80° C., cracks were observed in the coating layer.

Presumably, this is because the amount (amplitude) of first elastic torsion was too large, stress on the coating layer was increased, and cracking occurred in the coating layer.

Accordingly, it could be seen that the optical fiber wire obtained in the seventh comparative example was not practically preferable.

In the seventh comparative example, for the optical fiber wire to which the first elastic torsion was applied, it was confirmed that the maximum amplitude of elastic torsion, which remained and was held in the bare optical fiber portion in a state where the external force was removed after curing of the coating layer, was 5000 deg as a result of removing the coating layer of the optical fiber wire, from which the external force was removed, and measuring the rotation angle of the bare optical fiber after removing the coating layer according to the measurement method described above.

From the above result, elastic torsion applied to the coating layer is 25000 deg-5000 deg=20000 deg for the inversion period of 5 m.

Since this accumulated elastic torsion is applied to the coating layer with a ¼ of the period T1, it can be regarded that excessive elastic torsional force of 16000 deg/m is applied to the coating layer.

From the above examination results regarding elastic torsion applied to the coating layer of the optical fiber wire in the state where the external force was removed after the coating layer was cured in the respective experimental examples and comparative examples described above, there was no peeling or cracking of the coating when the amount of elastic torsion applied to the coating layer fell within the range of 1400 to 12800 deg/m.

On the other hand, as shown in the seventh comparative example, when the amount of elastic torsion applied to the coating layer was 16000 deg/m, peeling or cracking of the coating layer occurred. From this result, it can be seen that the preferable range of the amount of elastic torsion applied to the coating layer is 1400 to 12800 deg/m.

### Eighth Comparative Example

An optical fiber wire with a two-layer coating structure was manufactured by applying elastic torsion in the same manner as in the first experimental example.

For the viscosity of the coating resin at the time of coating, both the viscosity of the primary material and the viscosity of the secondary material were adjusted to 1 Pa·sec.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the torsion application device were set such that the period T1 became 10 m and the maximum amplitude MA of the accumulated torsion angle became 5000 deg.

The optical fiber wire after passing the torsion application device was picked up by a pickup device and was wound through a dancer pulley by a winding device. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 200 μm, and the secondary diameter was 250 μm.

Then, the optical fiber wire was rewound by a rewinding device while securing a distance (free length) of 20 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The twist profile of the second elastic torsion was a sine wave whose rotation direction changed, and the swing angle and the speed of the second elastic torsion application device were set such that the period T2 became 40 m and the maximum amplitude became 200 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.28 ps/√km (maximum amplitude of residual torsion was 0 deg), PMD2=0.28 (maximum amplitude of residual torsion was 0 deg), and PMD3=0.28 (maximum amplitude of residual torsion was 0 deg).

In addition, the PMD4 of the optical fiber wire sample when the second elastic torsion was completely released was 0.28.

In the eighth comparative example, since the amount of application (amplitude) of the second elastic torsion was too small, torsion was almost released by one rewinding. For this reason, the effect obtained by applying the second elastic torsion could not be confirmed.

From the above result, it can be seen that the preferable range of the amplitude of the second elastic torsion is 300 deg or more.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 1000 deg as a result of removing the coating layer of the optical fiber wire, from which the external force was removed, and measuring the rotation angle of the bare optical fiber after removing the coating layer according to the measurement method described above.

### Ninth Comparative Example

An optical fiber wire with a two-layer coating structure was manufactured by applying elastic torsion in the same manner as in the first experimental example.

For the viscosity of the coating resin at the time of coating, both the viscosity of the primary material and the viscosity of the secondary material were adjusted to 1 Pa·sec.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the torsion application device were set such that the period T1 became 10 m and the maximum amplitude MA of the accumulated torsion angle became 5000 deg.

The optical fiber wire after passing the torsion application device was picked up by a pickup device and was wound through a dancer pulley by a winding device. As a result, an optical fiber wire in which elastic torsion (twist) was applied to a bare optical fiber portion was obtained.

In the obtained optical fiber wire, the diameter of the bare wire was 125 μm, the primary diameter of the external diameter of the coat was 200 μm, and the secondary diameter was 250 μm.

Then, the optical fiber wire was rewound by a rewinding device while securing a distance (free length) of 20 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 40 m and the maximum amplitude became 8000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.2 ps/√km (maximum amplitude of residual torsion was 6600 deg), PMD2=0.15 (maximum amplitude of residual torsion was 6000 deg), and PMD3=0.2 (maximum amplitude of residual torsion was 5000 deg).

In addition, the PMD4 of the optical fiber wire sample when the second elastic torsion was completely released was 0.28.

In the ninth comparative example, since the amount of application (amplitude) of the second elastic torsion was too large, the PMD1 to PMD3 were high compared with those in the third experimental example.

That is, it was confirmed that the PMD could not be reduced effectively even if the amount of application (amplitude) of the second elastic torsion was very large.

Accordingly, in order to reduce the PMD efficiently, it is preferable that the amplitude of the second elastic torsion be 5000 deg or less.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 1000 deg as a result of removing the coating layer of the optical fiber wire, from which the external force was removed, and measuring the rotation angle of the bare optical fiber after removing the coating layer according to the measurement method described above.

### Fifth Experimental Example

An optical fiber wire was manufactured by applying the first elastic torsion and the second elastic torsion to a quartz glass-based optical fiber wire with a 2-layer coating structure, which has the characteristics of a typical single-mode fiber, according to the above-described method of the invention.

The apparatus shown in FIG. 8 was used as an optical fiber wire manufacturing apparatus, the device shown in FIG. 3 was used as a first torsion application device in the manufacturing apparatus, and the apparatus shown in FIG. 9 was used as a second torsion application device in the manufacturing apparatus.

The drawing speed (fiber drawing speed) from the optical fiber preform was set to 1000 mm/min.

A method of coating different coating resins at two places (wet on dry method) as shown in FIG. 8 was applied as a coating and curing method.

A UV-curable urethane acrylate-based resin (Young's modulus at the time of curing was 1.2 MPa) was used as a resin (primary material) of the first coating layer, and a UV-curable urethane acrylate-based resin (Young's modulus at the time of curing was 1300 MPa) was used as a resin (secondary material) of the second coating layer.

Moreover, for the viscosity of liquid resin at the time of coating of the above-described material, the viscosity of the primary material was adjusted to 3 Pa·sec and the viscosity of the secondary material was adjusted to 1 Pa·sec, and the optical fiber wire was coated with the primary material in the liquid state by the first coating device 20A and then cured by a UV lamp as the primary coat-curing device 22A.

Then, the optical fiber wire was coated with the secondary material was coated by the secondary coating device 20B and then cured by a UV lamp as the secondary coat-curing device 22B.

The first elastic torsion was applied immediately after the process of curing the secondary material by the secondary coat-curing device 2211

In addition, at the upstream side of the first torsion application device 26, fiber drawing was performed in a state where there was no physical contact with the optical fiber wire except for the coating resin.

Here, the profile of the first elastic torsion applied to the optical fiber wire 24 by the first torsion application device 26 was a sine wave which had a periodically reversed torsional direction, and the swing angle and the swing speed of the first torsion application device were set such that the period T1 became 5 m and the maximum amplitude MA of the accumulated torsion angle became 2500 deg.

The optical fiber wire 24 after passing the first torsion application device 26 was picked up by a pickup device (not shown) through the guide pulley 28 and was wound by a winding device through a dancer pulley. As a result, an optical fiber wire in which elastic torsion (twist) was given to a bare optical fiber portion was obtained.

In the obtained optical fiber wire, the diameter of the bare wire was 125 μm, the primary diameter of the external diameter of the coat (external diameter of the first coating layer) was 190 μm, and the secondary diameter (external diameter of the second coating layer) was 260 μm.

Then, the optical fiber wire was rewound by a rewinding device while securing a distance (free length) of 10 m so as not to be in physical contact with a member, such as a pulley, so that the torsion (part of the first elastic torsion) applied to the optical fiber wire was removed.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 40 m (8 times the period T1) and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in a stage where the second elastic torsion was not completely released was PMD1=0.03 ps/√km (maximum amplitude of residual torsion was 4000 deg), PMD2=0.08 (maximum amplitude of residual torsion was 3200 deg), and PMD3=0.1 (maximum amplitude of residual torsion was 2500 deg).

In addition, the PMD4 of the optical fiber wire sample when the second elastic torsion was completely released was 0.15, and the standard deviation was 0.05 ps/√km.

From the above result, also in the conditions in which the period T2 is 8 times the period T1, it could be seen that, among the PMD obtained by the four measurements described above, the highest PMD was PMD4 in a state where the second elastic torsion was completely released and only the first elastic torsion remained, and the PMD was low in cases where even the slight second elastic torsion remained (PMD1 to PMD3).

In addition, the standard deviation of the results of the above four PMD measurements was calculated, and the calculation result was 0.05 ps/√km. Accordingly, it could be seen that the variability was very small.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 750 deg as a result of removing the coating layer of the optical fiber wire, from which the external force was removed, and measuring the rotation angle of the bare optical fiber after removing the coating layer according to the measurement method described above.

### Sixth Experimental Example

An optical fiber wire with a two-layer coating structure was manufactured by applying the first elastic torsion and the second elastic torsion in the same manner as in the fifth experimental example.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the first torsion application device were set such that the period T1 became 5 m and the maximum amplitude MA of the accumulated torsion angle became 20000 (400×5) deg.

Other conditions were the same as those in the fifth experimental example.

Then, the optical fiber wire was rewound by a rewinding device while securing a distance (free length) of 20 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 40 m and the maximum amplitude became 500 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.04 ps/√km (maximum amplitude of residual torsion was 400 deg), PMD2=0.06 (maximum amplitude of residual torsion was 320 deg), and PMD3=0.11 (maximum amplitude of residual torsion was 160 deg).

In addition, the PMD4 of the optical fiber wire sample when the second elastic torsion was completely released was 0.13, and the standard deviation was 0.04 ps/√km.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 6000 deg as a result of removing the coating layer of the optical fiber wire, from which the external force was removed, and measuring the rotation angle of the bare optical fiber after removing the coating layer according to the measurement method described above.

From the above, also in the conditions in which the period T2 is 8 times the period T1, it could be seen that, among the PMD obtained by the four measurements described above, the highest PMD was PMD4 in a state where the second elastic torsion was completely released and only the first elastic torsion remained, and the PMD was low in cases where even the slight second elastic torsion remained (PMD1 to PMD3).

In addition, the standard deviation of the results of the four PMD measurements was calculated, and the calculation result was 0.04 ps/√km. Accordingly, it could be seen that the variability was very small.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 6000 deg as a result of removing the coating layer of the optical fiber wire, from which the external force was removed, and measuring the rotation angle of the bare optical fiber after removing the coating layer according to the measurement method described above.

### Seventh Experimental Example

An optical fiber wire with a two-layer coating structure was manufactured by applying the first elastic torsion and the second elastic torsion in the same manner as in the fifth experimental example.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the first torsion application device were set such that the period T1 became 10 m and the maximum amplitude MA of the accumulated torsion angle became 5000 (500×10) deg.

Other conditions were the same as those in the fifth experimental example.

Then, the optical fiber wire was rewound by a rewinding device while securing a distance (free length) of 20 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 80 m and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in a stage where the second elastic torsion was not completely released was PMD1=0.12 ps/√km (maximum amplitude of residual torsion was 4000 deg), PMD2=0.15 (maximum amplitude of residual torsion was 3200 deg), and PMD3=0.18 (maximum amplitude of residual torsion was 2500 deg).

In addition, the PMD4 of the optical fiber wire sample when the second elastic torsion was completely released was 0.25, and the standard deviation was 0.06 ps/√km.

From the above, also in the conditions in which the period T2 is 8 times the period T1, it could be seen that, among the PMD obtained by the four measurements described above, the highest PMD was PMD4 in a state where the second elastic torsion was completely released and only the first elastic torsion remained, and the PMD was low in cases where even the slight second elastic torsion remained (PMD1 to PMD3).

In addition, the standard deviation of the results of the four PMD measurements was calculated, and the calculation result was 0.06 ps/√km. Accordingly, it could be seen that the variability was very small.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 1500 deg as a result of removing the coating layer of the optical fiber wire, from which the external force was removed, and measuring the rotation angle of the bare optical fiber after removing the coating layer according to the measurement method described above.

### Eighth Experimental Example

An optical fiber wire with a two-layer coating structure was manufactured by applying the first elastic torsion and the second elastic torsion in the same manner as in the fifth experimental example.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the first torsion application device were set such that the period T1 became 10 m and the maximum amplitude MA of the accumulated torsion angle became 40000 (4000×10) deg.

Other conditions were the same as those in the fifth experimental example.

Then, the optical fiber wire was rewound by a rewinding device while securing a distance (free length) of 20 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 80 m and the maximum amplitude became 500 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in a stage where the second elastic torsion was not completely released was PMD1=0.1 ps/√km (maximum amplitude of residual torsion was 400 deg), PMD2=0.17 (maximum amplitude of residual torsion was 320 deg), and PMD3=0.14 (maximum amplitude of residual torsion was 250 deg).

In addition, the PMD4 of the optical fiber wire sample when the second elastic torsion was completely released was 0.23, and the standard deviation was 0.05 ps/√km.

From the above, also in the conditions in which the period T2 is 8 times the period T1, it could be seen that, among the PMD obtained by the four measurements described above, the highest PMD was PMD4 in a state where the second elastic torsion was completely released and only the first elastic torsion remained, and the PMD was low in cases where even the slight second elastic torsion remained (PMD1 to PMD3).

In addition, the standard deviation of the results of the four PMD measurements was calculated, and the calculation result was 0.05 ps/√km. Accordingly, it could be seen that the variability was very small.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 1200 deg as a result of removing the coating layer of the optical fiber wire, from which the external force was removed, and measuring the rotation angle of the bare optical fiber after removing the coating layer according to the measurement method described above.

### Tenth Comparative Example

An optical fiber wire with a two-layer coating structure was manufactured by applying the first elastic torsion and the second elastic torsion in the same manner as in the eighth experimental example.

The profile of the first elastic torsion in a longitudinal direction of the optical fiber wire, which was applied to the optical fiber wire by the first torsion application device, was a sine wave which had a periodically reversed torsional direction, and the swing angle and the swing speed of the first torsion application device were set such that the period T1 became 10 m and the maximum amplitude MA of the accumulated torsion angle became 5000 (500×10) deg.

Other conditions were the same as those in the fifth experimental example.

Then, the optical fiber wire was rewound by a rewinding device while securing a distance (free length) of 20 m so as not to be in physical contact with a member, such as a pulley, so that the torsion (part of the first elastic torsion) applied to the optical fiber wire was released.

Then, using the second elastic torsion application device shown in FIG. 9, the second elastic torsion was applied.

The profile of the second elastic torsion was a sine wave whose rotation direction changed, and the swing angle and the speed of the second elastic torsion application device were set such that the period T2 became 100 m and the maximum amplitude became 5000 deg.

For the optical fiber wire sample obtained as described above, each PMD value (PMD1 to PMD4) in a state where lateral pressure was intentionally applied was measured in the same manner as in the first experimental example.

As a result, the PMD value of the optical fiber wire sample in each stage where the second elastic torsion was not completely released was PMD1=0.04 ps/√km (maximum amplitude of residual torsion was 4000 deg), PMD2=0.17 (maximum amplitude of residual torsion was 3200 deg), and PMD3=0.26 (maximum amplitude of residual torsion was 2500 deg).

In addition, the PMD4 of the optical fiber wire sample when the second elastic torsion was completely released was 0.3, and the standard deviation was 0.12 ps/√km.

From the above, among the PMD obtained by the four measurements described above, the highest PMD was PMD4 in a state where the second elastic torsion was completely released and only the first elastic torsion remained.

When even the slight second elastic torsion remained (PMD1 to PMD3), the PMD was low but the standard deviation of the results of the four PMD measurements described above was 0.12 ps/√km. Accordingly, it could be seen that the variability was very large.

That is, under the conditions in which the period T2 was 10 times the period T1, that is, the period T2 was greater than 8 times the period T1, a PMD change by the amount of second elastic torsion was increased, and a preferable result was obtained accordingly.

In addition, for the optical fiber wire to which the first elastic torsion was applied, it was confirmed that the maximum amplitude of elastic torsion, which remained and was held in the bare optical fiber portion in a state where the external force was removed after curing of the coating layer, was 1500 deg as a result of removing the coating layer of the optical fiber wire, from which the external force was removed, and measuring the rotation angle of the bare optical fiber after removing the coating layer according to the measurement method described above.

It was confirmed that the maximum amplitude was 1500 deg.

The elastic torsion application conditions in the above experimental examples and comparative examples are summarized in Table 1, and these results (PMD suppression effects) are summarized in Table 2.

TABLE 1

| | | | Residual | | | |
|---|---|---|---|---|---|---|
| | Period | Amplitude | amplitude | Period of | Amplitude | Amount of |
| | of first | of first | of first | second | of second | elastic |
| | elastic | elastic | elastic | elastic | elastic | torsion of |
| | torsion | torsion | torsion | torsion | torsion | coating layer |
| | [m] | [deg] | [deg] | [m] | [deg] | [deg/m] |
| First experimental example | 5 | 2500 | 500 | 20 | 500 | 1600 |
| Second experimental example | 5 | 20000 | 4000 | 20 | 5000 | 12800 |
| Third experimental example | 10 | 5000 | 1000 | 40 | 300 | 1600 |
| Fourth experimental example | 10 | 40000 | 8000 | 40 | 5000 | 12800 |
| Fifth experimental example | 5 | 2500 | 750 | 40 | 5000 | 1400 |
| Sixth experimental example | 5 | 20000 | 6000 | 40 | 500 | 11200 |
| Seventh experimental example | 10 | 5000 | 1500 | 80 | 5000 | 1400 |
| Eighth experimental example | 10 | 40000 | 12000 | 80 | 500 | 11200 |
| First comparative example | — | — | — | 5 | 2500 | — |
| Second comparative example | 5 | 2500 | 500 | 5 | 5000 | 1600 |
| Third comparative example | 5 | 2500 | 500 | 10 | 4000 | 1600 |
| Fourth comparative example | 5 | 2500 | 250 | 20 | 5000 | 1800 |
| Fifth comparative example | 5 | 2500 | — | — | — | — |
| Sixth comparative example | 3 | 1500 | 100 | 30 | 5000 | 1867 |
| Seventh comparative example | 5 | 25000 | 5000 | 20 | 5000 | 16000 |
| Eighth comparative example | 10 | 5000 | 1000 | 40 | 200 | 1600 |
| Ninth comparative example | 10 | 5000 | 1000 | 40 | 8000 | 1600 |
| Tenth comparative example | 10 | 5000 | 1500 | 100 | 5000 | 1400 |

TABLE 2

| | PMD1 | | PMD2 | | PMD3 | | PMD4 | | |
|---|---|---|---|---|---|---|---|---|---|
| | PMD value | PMD change | PMD value | PMD change | PMD value | PMD change | PMD value | PMD change | σ |
| | ps/\sqrt{km} | rate | ps/\sqrt{km} | rate | ps/\sqrt{km} | rate | ps/km | rate | ps/\sqrt{km} |
| First experimental | 0.05 | 0.09 | 0.1 | 0.18 | 0.13 | 0.24 | 0.18 | 0.33 | 0.05 |
| example | | | | | | | | | |
| Second experimental | 0.08 | 0.15 | 0.04 | 0.07 | 0.06 | 0.11 | 0.16 | 0.29 | 0.05 |
| example | | | | | | | | | |
| Third experimental | 0.1 | 0.18 | 0.14 | 0.25 | 0.2 | 0.36 | 0.28 | 0.51 | 0.08 |
| example | | | | | | | | | |
| Fourth experimental | 0.04 | 0.07 | 0.05 | 0.09 | 0.03 | 0.05 | 0.12 | 0.22 | 0.04 |
| example | | | | | | | | | |
| Fifth experimental | 0.03 | 0.05 | 0.08 | 0.15 | 0.1 | 0.18 | 0.15 | 0.27 | 0.05 |
| example | | | | | | | | | |
| Sixth experimental | 0.04 | 0.07 | 0.06 | 0.11 | 0.11 | 0.2 | 0.13 | 0.24 | 0.04 |
| example | | | | | | | | | |
| Seventh experimental | 0.12 | 0.22 | 0.15 | 0.27 | 0.18 | 0.33 | 0.25 | 0.45 | 0.06 |
| example | | | | | | | | | |
| Eighth experimental | 0.1 | 0.18 | 0.17 | 0.31 | 0.14 | 0.25 | 0.23 | 0.42 | 0.05 |
| example | | | | | | | | | |
| First comparative | 0.05 | 0.09 | 0.21 | 0.38 | 0.23 | 0.42 | 0.55 | 1 | 0.21 |
| example | | | | | | | | | |
| Second comparative | 0.04 | 0.07 | 0.2 | 0.36 | 0.25 | 0.45 | 0.18 | 0.33 | 0.09 |
| example | | | | | | | | | |
| Third comparative | 0.1 | 0.18 | 0.05 | 0.09 | 0.2 | 0.36 | 0.18 | 0.33 | 0.07 |
| example | | | | | | | | | |
| Fourth comparative | 0.05 | 0.09 | 0.12 | 0.22 | 0.15 | 0.27 | 0.35 | 0.64 | 0.13 |
| example | | | | | | | | | |
| Fifth comparative | — | — | — | — | — | — | — | — | — |
| example | | | | | | | | | |
| Sixth comparative | 0.28 | 0.51 | 0.3 | 0.55 | 0.38 | 0.69 | 0.4 | 0.73 | 0.06 |
| example | | | | | | | | | |
| Seventh comparative | 0.04 | 0.07 | 0.1 | 0.18 | 0.08 | 0.15 | 0.12 | 0.22 | 0.03 |
| example | | | | | | | | | |
| Eighth comparative | 0.28 | 0.51 | 0.28 | 0.51 | 0.28 | 0.51 | 0.28 | 0.51 | 0 |
| example | | | | | | | | | |
| Ninth comparative | 0.2 | 0.36 | 0.15 | 0.27 | 0.2 | 0.36 | 0.28 | 0.51 | 0.05 |
| example | | | | | | | | | |
| Tenth comparative | 0.04 | 0.07 | 0.17 | 0.31 | 0.26 | 0.47 | 0.3 | 0.55 | 0.12 |
| example | | | | | | | | | |

While the preferred experimental examples of the invention have been described, the invention is not limited to these experimental examples.

That is, addition, omission, and replacement of the configuration and other modifications could be made without departing from the scope of the invention.

The invention is not limited by the above description but is defined by only the appended claims.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An optical fiber comprising:
an optical fiber wire, wherein
the optical fiber wire comprises a bare optical fiber portion, to which first elastic torsion is applied, and a coating layer, which coats the bare optical fiber portion and which is formed of curable resin and generates elastic repulsion against resilience occurring in the bare optical fiber portion so that the first elastic torsion applied to the bare optical fiber portion is held, and
second elastic torsion is applied to the entire optical fiber wire including the bare optical fiber portion and the coating layer.

2. The optical fiber according to claim 1, wherein
as the first elastic torsion applied to the bare optical fiber portion, first direction torsion generated in a first direction and second direction torsion generated in a second direction, the second direction being an opposite direction to the first direction, are alternately applied to the bare optical fiber portion every predetermined length in a longitudinal direction of the optical fiber wire, and
as the second elastic torsion applied to the entire optical fiber wire, the first direction torsion and the second direction torsion are alternately applied to the entire optical fiber wire every predetermined length in a longitudinal direction of the optical fiber wire.

3. The optical fiber according to claim 2, wherein
a sum of a length of a first section, in which the first direction torsion in the longitudinal direction of the optical fiber wire continues, and a length of a second section, which is adjacent to the first section and in which the second direction torsion continues, is defined as an inversion period of torsion, and
a second inversion period T2 of the second elastic torsion is longer than a first inversion period T1 of the first elastic torsion.

4. The optical fiber according to claim 3, wherein
the first inversion period T1 is in a range of 5 to 10 m, and
the second inversion period T2 is in a range of 4 to 8 times the inversion period T1 of the first elastic torsion.

5. The optical fiber according to claim 4, wherein,
in a reverse torsion profile of the first elastic torsion which remains and is held by elastic repulsion of the coating layer, the maximum amplitude of an accumulated torsion angle is 100×T1 (deg) to 1200×T1 (deg), and the maximum amplitude of an accumulated torsion angle of the second elastic torsion is 300 deg to 5000 deg.

6. The optical fiber according to claim 5, wherein,
in the coating layer, the amount of elastic torsion generated in a restoration direction of the first elastic torsion applied to the bare optical fiber portion is 1400 deg/m to 12800 deg/m.

7. A method of manufacturing an optical fiber with an optical fiber wire, comprising:
coating a bare optical fiber portion with uncured curable resin;
applying first elastic torsion to an optical fiber wire before the curable resin is cured;
forming an optical fiber wire to which torsion is applied so that the first elastic torsion of the bare optical fiber portion is held by curing the curable resin coated on the bare optical fiber portion to which the first elastic torsion is applied; and
applying second elastic torsion to the entire optical fiber wire after the curable resin is cured.

8. The optical fiber manufacturing method according to claim 7, wherein
an optical fiber preform is heated and melted,
a bare optical fiber portion with a predetermined diameter is drawn from the melted optical fiber preform,
the drawn bare optical fiber portion is solidified,
the first elastic torsion is applied to the solidified bare optical fiber portion by transmitting elastic torsion to the bare optical fiber portion toward an upstream side in a drawing direction of the bare optical fiber portion,
a coating layer before curing is formed by coating an outer periphery of the solidified bare optical fiber portion with curable resin in a liquid state,
at least a part of the first elastic torsion is held in the bare optical fiber portion by curing the coating layer formed on the outer periphery of the bare optical fiber portion to which the first elastic torsion is applied, and
second elastic torsion is applied to an entire optical fiber wire obtained after curing of the curable resin.

9. The optical fiber manufacturing method according to claim 8, wherein
the first elastic torsion is applied to the bare optical fiber portion using a first torsion application device, and
the first elastic torsion is applied to the bare optical fiber portion in a state where a member, the member preventing transmission of torsion of the bare optical fiber portion, is not present at an upstream side of the first torsion application device.

10. The optical fiber manufacturing method according to claim 8, wherein,
when coating curable resin on the optical fiber, viscosity of the curable resin in a liquid state at the time of coating is 0.1 to 3 Pa·sec, and
when applying the first elastic torsion to the optical fiber, a direction of torsion applied to the bare optical fiber portion is periodically reversed.

11. The optical fiber manufacturing method according to claim 8, wherein
a sum of a length of a first section, in which first direction torsion generated in a first direction in a longitudinal direction of the optical fiber wire continues, and a length of a second section, which is adjacent to the first section and in which second direction torsion generated in a second direction opposite the first direction continues, is defined as an inversion period of torsion,
when applying the first elastic torsion to the optical fiber wire, a direction of the torsion is periodically reversed,
when applying the second elastic torsion to the optical fiber wire, a direction of the torsion is periodically reversed, and
a second inversion period T2 of the second elastic torsion is longer than a first inversion period T1 of the first elastic torsion.

12. The optical fiber manufacturing method according to claim 11, wherein,
when applying the first elastic torsion to the optical fiber wire, the first inversion period T1 of the first elastic torsion in the longitudinal direction of the optical fiber wire is 5 to 10 m, and
in a reverse torsion profile of the first elastic torsion, the maximum amplitude of an accumulated torsion angle is 500×T1 (deg) to 4000×T1 (deg).

13. The optical fiber manufacturing method according to claim 11, wherein
the first inversion period T1 of the bare optical fiber portion, in which at least a part of the first elastic torsion applied to the optical fiber wire is held due to elastic repulsion of the coating layer, in the longitudinal direction of the optical fiber wire is 5 to 10 m, and
in a reverse torsion profile of the optical fiber wire, the maximum amplitude MA of an accumulated torsion angle is 100×T1 (deg) to 1200×T1 (deg).

14. The optical fiber manufacturing method according to claim 13, wherein,
when at least a part of the first elastic torsion applied to the optical fiber wire is held in the bare optical fiber portion, the amount of elastic torsion, which is generated in a restoration direction of the first elastic torsion applied to the bare optical fiber portion, in the coating layer is 1400 deg/m to 12800 deg/m.

15. The optical fiber manufacturing method according to claim 12, wherein
the second inversion period T2 is 4 to 8 times the first inversion period T1 when applying the first elastic torsion, and
the maximum amplitude of an accumulated torsion angle when applying the second elastic torsion is 300 deg to 5000 deg.

16. The optical fiber manufacturing method according to claims 13, wherein
the second inversion period T2 is 4 to 8 times the first inversion period T1 when applying the first elastic torsion, and
the maximum amplitude of an accumulated torsion angle when applying the second elastic torsion is 300 deg to 5000 deg.

17. An optical fiber manufacturing apparatus comprising:
a heating furnace for drawing which heats and melts an optical fiber preform;
a cooling device which forcibly cools a bare optical fiber portion, which is linearly drawn downward from the heating furnace for drawing, in order to solidify the bare optical fiber portion;
a coating device which forms a coating layer by coating curable resin for protecting the bare optical fiber portion on the cooled and solidified bare optical fiber portion;
a coat-curing device which cures the uncured coating layer coated by the coating device;
a first torsion application device which gives first elastic torsion to the solidified bare optical fiber portion by transmitting elastic torsion to the bare optical fiber portion toward an upstream side in a drawing direction of the bare optical fiber portion; and
a second torsion application device which applies second elastic torsion, which is different from the first elastic torsion, to an entire optical fiber wire in which at least a part of the first elastic torsion applied to the bare optical fiber portion is held.
